(19) United States
(12) Patent Application Publication
(10) Pub. No.: US 2024/0199800 A1
(43) Pub. Date: Jun. 20, 2024

(54) METHODS FOR PRODUCTION OF BIODEGRADABLE POLYESTERS

(71) Applicant: Novomer, Inc., Rochester, NY (US)

(72) Inventors: Christopher A. DeRosa, Rochester, NY (US); Eric Stoutenburg, Rochester, NY (US)

(21) Appl. No.: 18/278,514

(22) PCT Filed: Feb. 24, 2022
(86) PCT No.: PCT/US2022/017599

§ 371 Date: Aug. 23, 2023

Related U.S. Application Data
(60) Provisional application No. 63/154,014, filed on Feb. 26, 2021.

(51) Int. Cl. C08G 63/685

(52) U.S. Cl. CPC C08G 63/6852

(57) ABSTRACT

Disclosed are methods of efficiently making poly(3-hydroxypropionate) (polypropiolactones) and related copolymers from 3-hydroxypropionate (beta propiolactone) utilizing zwitterionic polymerization initiators. In another aspect, the present invention provides polymerization systems comprising combinations of initiators and monomers that together enable the efficient production of poly(3-hydroxypropionate) (polypropiolactones) and related copolymers. Disclosed are novel polymer compositions having structures and/or compositional characteristics that differentiate them from previously produced polymers and polymer compositions.

### CROSS-REFERENCE TO RELATED APPLICATIONS

This application is a National Stage Filing under 35 USC 371 of the PCT Application No. PCT/US2022/017599 filed Feb. 24, 2022, published Sep. 1, 2022 as WO2022/182810 which claims priority from provisional application U.S. Ser. No. 63/154,014 filed Feb. 26, 2021, both of which are incorporated herein by reference in its entirety for all purposes.

### BACKGROUND

Polyester polymers have proven to be versatile materials with a wide range of uses. Polyesters based on petroleum-derived aromatic monomers are among the most widely utilized polymers, for example polyethylene terephthalate (PET) is produced on massive scale to produce water bottles, textiles and other consumer goods. Unfortunately, PET is not biodegradable and as such has become a major contributor to the growing problem of environmental contamination by residual post-consumer plastic wastes, including damage to marine ecosystems. In recent years there has been increasing interest in biodegradable polyesters, examples include polylactic acid (PLA) and poly-3-hydroxybutyrate (PHB). These polymers' high cost and properties have made it difficult to serve large volume applications to displace incumbent high-volume polymers. There remains a need for high performance biodegradable polyesters and for methods of making such polymers from flexible feedstock sources that allow manufacturers to balance the cost and sustainability profiles of their products. The present disclosure provides solutions to these and other related problems.

### SUMMARY

Disclosed are processes for the polymerization of beta lactones using zwitterionic initiators for the preparation of high molecular weight biodegradable polyesters and biodegradable polyester copolymers with superior properties. It has not previously been possible to economically produce very high molecular weight poly(3-hydroxypropionate) (p3HP) or related copolymers, nor has it been straightforward to control the compositional properties and secondary structures of such polymers to optimize them for many applications. Disclosed are methods of efficiently making poly(3-hydroxypropionate) and related copolymers by utilizing zwitterionic polymerization initiators. The produced polymers may have unique properties which make them suitable for demanding commercial applications and which differentiate them from known polyesters made by other methods. Disclosed are polymerization systems comprising unique combinations of initiators, monomers, oligomers, end capping agents, chain extenders, chain transfer agents, and crosslinking agents that enable the production of superior polymer products. Disclosed are polymer compositions having structures and/or compositional characteristics that differentiate them from previously produced polymers and polymer compositions.

Disclosed are polymer comprising one or more polymer chains of polymers of beta-propiolactone and/or substituted beta-propiolactone and having on one end of the chains a residue of a zwitterion having an anion and a cation wherein the anion portion is covalently bonded to the one end of the polymer chains. The one or more polymer chains may have the residue of an end capping agent on the other end of the chains. The end capping agent may be one or more of an organohalide, organosulfonate, a haloalkyl silane, an aniline derivative, a phosphate derivative, and an isophthalic acid derivative. The anion may be an oxygen or sulfur-based anion and the cation may be an organic onium cation. The onium cations may contain nitrogen, phosphorus, sulfur, antimony or arsenic. The anion and cation of the Zwitterion may be linked by a bond or a multivalent organic moiety. The polymer may comprise chains according to Formula P-I or P-II:

+Z-L-X-(A)-H, P-I,

+Z-L-X-(A)-R^{k}, p-II;

wherein: A may be separately in each occurrence a polymer chain having ring opened beta propiolactone and/or substituted betapropiolactone units; Z may be separately in each occurrence a cation derived from a Zwitterion; L may be separately in each occurrence a bond or a multivalent organic moiety; X may be separately in each occurrence an anion derived from a Zwitterion; and R^{k} may be separately in each occurrence the residue of an endcapping agent. A may be separately in each occurrence polymer chain comprising units derived from 3-hydroxypropionate and/or substituted 3-hydroxypropionate. Z may be separately in each occurrence an organic onium cation. L may be separately in each occurrence an optionally substituted C₁-C₁₀₀ aliphatic group. X may be separately in each occurrence an oxygen or sulfur-based anion. R^{k} may be separately in each occurrence the residue of an end capping agent which may be one or more of an organohalide, organosulfonate, a haloalkyl silane, an aniline derivative, a phosphate derivative, and an isophthalic acid derivative Z may be separately in each occurrence an organic onium cation wherein the onium cations contain nitrogen, phosphorus, sulfur, antimony or arsenic. L may be separately in each occurrence an optionally substituted C₁-C₄₀ aliphatic group.

Disclosed is a polymerizable composition comprising: a. one or more of beta propiolactone and/or substituted betapropiolactones; and b. one or more zwitterionic initiators. The polymerizable composition may contain one or more comonomers which copolymerize with one or more of beta propiolactone and/or substituted betapropiolactones. The ratio of the one or more of beta propiolactone and/or substituted betapropiolactones to the one or more zwitterionic initiators may be from about 100 to 1 to about 1,000,000 to 1. The end-capping agent may be present in an amount of less than 10 molar equivalents relative to the amount of zwitterionic initiator added. The polymerizable composition may comprise comonomers are one or more of caprolactones, lactides, epoxides, oxetanes, cyclic anhydrides, lactams, episulfides, aziridines, (meth)acrylates, valerolactones, butyrolactone and glycolides. The polymerizable composition may comprise one or more of end capping agents, chain transfer agents, quenching agents, chain extenders, branching agents, and the like. The polymerizable composition may contain one or more of chain transfer agents, chain extenders and end capping agents.

Disclosed is a method comprising contacting one or more of beta propiolactone and/or substituted betapropiolactones and comonomers with one or more zwitterionic initiators under conditions to prepare one or more polymers comprising one or more polymer chains having ring opened beta propiolactone and/or substituted betapropiolactone units and having on one end of the chains a residue of a zwitterion having an anion and a cation wherein the anion portion is covalently bonded to the one end of the polymer chains. The one or more of beta propiolactone and/or substituted betapropiolactones and comonomers and one or more zwitterionic initiators may be contacted at a temperature of from about 0° C. to about 120° C. The one or more of beta propiolactone and/or substituted betapropiolactones and comonomers and one or more zwitterionic initiators may be contacted at a pressure of between about 1 bar and about 20 bar. The one or more of beta propiolactone and/or substituted betapropiolactones and comonomers and one or more zwitterionic initiators are contacted for a time sufficient to get to the desired molecular weight of the one or more of beta propiolactone and/or substituted betapropiolactones and comonomers. The quenching agent may be one or more of mineral acids, organic acids, acidic resins or solids, and an end capping agent.

### DESCRIPTION OF FIGURE

FIG. 1 shows the Comparison of Molar masses from betaine and lauryl-betaine at various M:I ratios, based on data from Table 1.

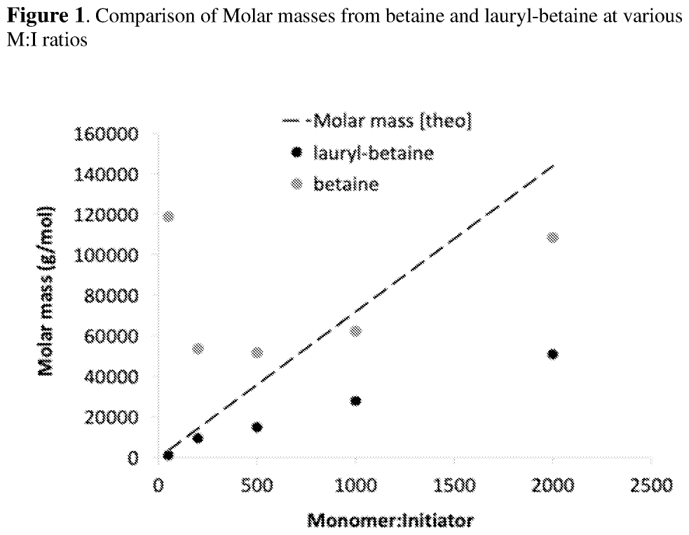

### DETAILED DESCRIPTION

### Definitions

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

Certain polymers disclosed can comprise one or more asymmetric centers, and thus can exist in various stereoisomeric forms, e.g., enantiomers and/or diastereomers. The polymers and compositions thereof may be in the form of an individual enantiomer, diastereomer or geometric isomer, or may be in the form of a mixture of stereoisomers. The polymers disclosed may be enantiopure compounds. Disclosed are mixtures of enantiomers or diastereomers.

Certain polymers disclosed comprise monomers capable of enchainment by reaction at more than one site and may therefore create the possibility of regioisomerism in the resulting polymer chains. Certain polymers disclosed can exist in different regio-isomeric forms. Certain polymers and compositions thereof described herein may be regioregular or may comprise degrees of regio-irregularity or even be substantially regio-random. The polymers disclosed may be substantially regioregular. Polymers disclosed may comprise one or more crystalline polymorphs, and thus can exist in various crystalline forms. Polymers and compositions thereof may be in the form of β crystalline polymorph, γ crystalline polymorph, δ crystalline polymorph, or may be in the form of a mixture of crystalline polymorphs. Certain polymers, as described herein may have one or more double bonds that can exist as either the Z or E isomer, unless otherwise indicated. Disclosed are polymers as individual isomers substantially free of other isomers and alternatively, as mixtures of various isomers, e.g., racemic mixtures of enantiomers. The above-mentioned polymers per se, may encompass compositions comprising one or more polymers. As used herein, the term “isomers” includes all geometric isomers, stereoisomers and regio-isomers. For example, “isomers” include cis- and trans- isomers, E- and Z- isomers, R-and S-enantiomers, diastereomers, (D)-isomers, (L)-isomers, racemic mixtures thereof, and other mixtures thereof. For instance, a stereoisomer may, in some embodiments, be provided substantially free of one or more corresponding stereoisomers, and may also be referred to as “stereochemically enriched.”

The term “beta lactone”, as used herein, refers to a substituted or unsubstituted cyclic ester having a four-membered ring comprising an oxygen atom, a carbonyl group and two optionally substituted methylene groups. When unsubstituted, the beta lactone is referred to as propiolactone. Substituted beta lactones include monosubstituted, disubstituted, trisubstituted, and tetrasubstituted beta lactonesThe beta lactones comprise a single lactone moiety. The beta lactones may comprise two or more four-membered cyclic ester moieties.

The term “epoxide”, as used herein, refers to a substituted or unsubstituted oxirane. Such substituted oxiranes include monosubstituted oxiranes, disubstituted oxiranes, trisubstituted oxiranes, and tetrasubstituted oxiranes. The epoxides comprise a single oxirane moiety. The epoxides comprise two or more oxirane moieties.

The term “polymer”, as used herein, refers to a molecule of high relative molecular mass, the structure of which comprises the multiple repetition of units derived, actually or conceptually, from molecules of low relative molecular mass. The polymer may be comprised of beta lactone monomers (e.g., polypropiolactone). The polymers disclosed may be a copolymer, terpolymer, heteropolymer, block copolymer, or tapered heteropolymer incorporating two or more different monomers. With respect to the structural depiction of such higher polymers, the convention of showing enchainment of different monomer units or polymer blocks separated by a slash may be used herein. For example, a structure:

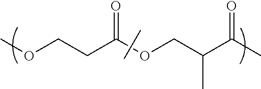

could be used to represent a copolymer of beta propiolactone and beta butyrolactone. Such structures are to be interpreted to encompass copolymers incorporating any ratio of the different monomer units depicted unless otherwise specified. This depiction is also meant to represent random, tapered, block copolymers, and combinations of any two or more of these all of which are implied unless otherwise specified.

The terms “halo” and “halogen” as used herein refer to an atom selected from fluorine (fluoro, —F), chlorine (chloro, —Cl), bromine (bromo, —Br), and iodine (iodo, —I). The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Aliphatic groups may contain 1-40 carbon atoms, 1-20 carbon atoms, 2-20 carbon atoms, 1-12 carbon atoms, 1-8 carbon atoms, 1-6 carbon atoms, 1-5 carbon atoms, 1-4 carbon atoms, 1-3 carbon atoms, or 1 or 2 carbon atoms. Exemplary aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl. The term “heteroaliphatic,” as used herein, refers to aliphatic groups wherein one or more carbon atoms are independently replaced by one or more atoms selected from the group consisting of oxygen, sulfur, nitrogen, or phosphorus. One to six carbon atoms may be independently replaced by one or more of oxygen, sulfur, nitrogen, or phosphorus. Heteroaliphatic groups may be substituted or unsubstituted, branched or unbranched, cyclic or acyclic, and include saturated, unsaturated, or partially unsaturated groups. The term “unsaturated”, as used herein, means that a moiety has one or more double or triple bonds. The terms “cycloaliphatic”, “carbocycle”, or “carbocyclic”, used alone or as part of a larger moiety, refer to a saturated or partially unsaturated cyclic aliphatic monocyclic or polycyclic ring system, as described herein, having from 3 to 12 members, wherein the aliphatic ring system is optionally substituted as defined below and described herein. Cycloaliphatic groups include, without limitation, cyclopropyl, cyclobutyl, cyclopentyl, cyclopentenyl, cyclohexyl, cyclohexenyl, cycloheptyl, cycloheptenyl, cyclooctyl, cyclooctenyl, norbornyl, adamantyl, and cyclooctadienyl. A cycloaliphatic group may have 3-6 carbons. The terms “cycloaliphatic”, “carbocycle” or “carbocyclic” also include aliphatic rings that are fused to one or more aromatic or nonaromatic rings, such as decahydronaphthyl or tetrahydronaphthyl, where the radical or point of attachment is on the aliphatic ring.

The term “alkenyl,” as used herein, denotes a monovalent group derived from a straight- or branched-chain aliphatic moiety having at least one carbon—carbon double bond by the removal of a single hydrogen atom. The term “alkynyl,” as used herein, refers to a monovalent group derived from a straight- or branched-chain aliphatic moiety having at least one carbon—carbon triple bond by the removal of a single hydrogen atom. The term “alkoxy”, as used herein refers to an alkyl group, as previously defined, attached to the parent molecule through an oxygen atom. Examples of alkoxy, include but are not limited to, methoxy, ethoxy, propoxy, isopropoxy, n-butoxy, tert-butoxy, neopentoxy, and n-hexoxy. The term “acyl”, as used herein, refers to a carbonyl-containing functionality, e.g., —C(═O)R′, wherein R′ is hydrogen or an optionally substituted aliphatic, heteroaliphatic, heterocyclic, aryl, heteroaryl group, or is a substituted (e.g., with hydrogen or aliphatic, heteroaliphatic, aryl, or heteroaryl moieties) oxygen or nitrogen containing functionality (e.g., forming a carboxylic acid, ester, or amide functionality). The term “acyloxy”, as used here, refers to an acyl group attached to the parent molecule through an oxygen atom. The term “aryl” used alone or as part of a larger moiety as in “aralkyl”, “aralkoxy”, or “aryloxyalkyl”, refers to monocyclic and polycyclic ring systems having a total of five to 20 ring members, wherein at least one ring in the system is aromatic and wherein each ring in the system contains three to twelve ring members. The term “aryl” may be used interchangeably with the term “aryl ring” wherein “aryl” refers to an aromatic ring system which includes, but is not limited to, phenyl, biphenyl, naphthyl, anthracyl and the like, which may bear one or more substituents. Also included within the scope of the term “aryl”, as it is used herein, is a group in which an aromatic ring is fused to one or more additional rings, such as benzofuranyl, indanyl, phthalimidyl, naphthimidyl, phenantriidinyl, or tetrahydronaphthyl, and the like, where the radical or point of attachment is on the aryl ring. The terms “heteroaryl” and “heteroar—”, used alone or as part of a larger moiety, e.g., “heteroaralkyl”, or “heteroaralkoxy”, refer to groups having 5 to 14 ring atoms, preferably 5, 6, or 9 ring atoms; having 6, 10, or 14 π electrons shared in a cyclic array; and having, in addition to carbon atoms, from one to five heteroatoms. The term “heteroaryl” may be used interchangeably with the terms “heteroaryl ring” and “heteroaryl group”, any of which terms include rings that are optionally substituted. The term “heteroatom” refers to nitrogen, oxygen, or sulfur, and includes any oxidized form of nitrogen or sulfur, and any quaternized form of a basic nitrogen. Heteroaryl groups include, without limitation, thienyl, furanyl, pyrrolyl, imidazolyl, pyrazolyl, triazolyl, tetrazolyl, oxazolyl, isoxazolyl, oxadiazolyl, thiazolyl, isothiazolyl, thiadiazolyl, pyridyl, pyridazinyl, pyrimidinyl, pyrazinyl, indolizinyl, purinyl, naphthyridinyl, benzofuranyl and pteridinyl. The terms “heteroaryl” and “heteroar—”, as used herein, also include groups in which a heteroaryl ring is fused to one or more aryl, cycloaliphatic, or heterocyclyl rings, where the radical or point of attachment is on the heteroaryl ring. Nonlimiting examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido[2,3-b]-1,4-oxazin-3(4H)-one. A heteroaryl group may be mono— or bicyclic. The term “heteroaralkyl” refers to an alkyl group substituted by a heteroaryl, wherein the alkyl and heteroaryl portions independently are optionally substituted. In certain embodiments, the term “5- to 10-membered heteroaryl” refers to a 5- to 6-membered heteroaryl ring having 1 to 3 heteroatoms independently selected from nitrogen, oxygen, or sulfur, or an 8- to 10-membered bicyclic heteroaryl ring having 1 to 4 heteroatoms independently selected from nitrogen, oxygen, or sulfur. The term “partially unsaturated” refers to a ring moiety that includes at least one double or triple bond. The term “partially unsaturated” is intended to encompass rings having multiple sites of unsaturation but is not intended to include aryl or heteroaryl moieties, as herein defined.

The compounds disclosed may contain “optionally substituted” moieties. The term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned are those that result in the formation of stable or chemically feasible compounds. The term “stable”, as used herein, refers to compounds that are not substantially altered when subjected to conditions to allow for their production, detection, and, in certain embodiments, their recovery, purification, and use for one or more of the purposes disclosed herein. As used herein the term “alkoxylated” means that one or more functional groups on a molecule (usually the functional group is an alcohol, amine, or carboxylic acid, but is not strictly limited to these) has appended to it a hydroxy-terminated alkyl chain. Alkoxylated compounds may comprise a single alkyl group or they may be oligomeric moieties such as hydroxyl-terminated polyethers. Unless otherwise specified, “a,” “an,” “the,” and “at least one” are used interchangeably and mean one or more than one.

### Methods

Disclosed are methods of polymerizing beta propiolactone (BPL) and/or substituted beta propiolactone optionally in combination with one or more additional co-monomers (collectively monomers), using a zwitterionic polymerization initiator. The initiator may, or may not be, covalently attached in the final polymer product.

### Feed Ratios and Polymer Characteristics

The method comprises contacting the monomers with a zwitterionic initiator wherein a molar ratio of monomers to initiator is selected so as to prepare a polymer of the desired molecular weight, for example the mole ratio may be 10:1 or greater, 100:1 or greater, 1,000:1, or greater, 2,000:1 or greater, 3,000:1 or greater, 4,000:1 or greater, 5,000:1 or greater, 7,500:1 or greater, 10,000:1 or greater, 15,000:1 or greater, 20,000:1 or greater, 30,000:1 or greater, 40,000:1 or greater, 50,000:1 or greater, 75,000:1 or greater, or 100,000:1 or greater. The initiator is contacted with the momomers for sufficient time to prepare polymers of the desired molecular weight. The method may comprise the step of allowing the initiator to contact the monomers until a polymer composition having a number average molecular weight Mₙ of 50,000 g/mol or greater, 75,000 g/mol or greater, 100,000 g/mol or greater, 150,000 g/mol or greater, 200,000 g/mol or greater, 250,000 g/mol or greater, 300,000 g/mol or greater, 400,000 g/mol or greater, 500,000 g/mol or greater, 600,000 g/mol or greater, or 700,000 g/mol or greater, is formed. Mn of the polymer composition refers to that measured by gel permeation chromatography (GPC) using CHCl₃ as the solvent and referenced to polymethyl methacrylate standards.

A GPC chromatogram of the produced polymer composition may be multimodal and include one or more peaks representing a distinct population of low molecular weight oligomers (e.g. polyester chains) having a molecular weight of about 5,000 g/mol or less, about 4,500 or less, about 4,000 or less, about 3,500 or less, about 3,000 or less, about 2,500 or less, about 2,000 or less, about 1,500 or less or about 1,000 g/mol or less. The GPC chromatogram of the produced polymer composition, the ratio of the area of peaks resulting from polymer chains having an Mn above 50,000 g/mol to the area of peaks representing oligomers with Mn below 5,000 g/mol may be at least 10:1.

The method includes allowing the zwitterionic initiator to contact the monomers for a prescribed interval of time. The method may include the step of monitoring the progress of the polymerization reaction (for example by analyzing aliquots from the reaction mixture by a suitable technique such as GPC, or by utilizing in situ monitoring techniques). The method may include the step of monitoring the increase in the molecular weight of the polymer and/or monitoring a decrease in monomers concentration. The method may include stopping the reaction when the molecular weight of the polymer composition (or a proxy for molecular weight such as reaction viscosity) reaches a desired value or exceeds a predetermined threshold. The method may include the step of monitoring the depletion of monomers until their concentration reaches a desired concentration or falls below a predetermined threshold. The method may include the step of stopping the reaction when the concentration of monomers reaches a desired concentration or falls below a predetermined threshold.

The polymer composition formed may have a low polydispersity, a polydispersity index (PDI) of 3.5 or less, 3.0 or, 2.5 or less or 2.2 or less. The polymer composition formed may have a PDI of 1.05 or greater, 1.1 or greater, 1.2 or greater, 1.5 or greater or 2.0 or greater. The PDI values recited refer to that measured by GPC. The PDI values may be calculated without inclusion of GPC peaks arising from oligomers having Mn less than about 5,000 g/mol, less than about 4,500, less than about 4,000, less than about 3,500, less than about 3,000, less than about 2,500, less than about 2,000, less than about 1,500 or less than about 1,000 g/mol.

The method may be characterized in that the polymer composition formed has an M_{N} between 20,000 g/mol and 200,000 g/mol and a PDI less than 1.5. The method may be characterized in that the polymer composition formed has a M_{N} between 20,000 g/mol and 50,000 g/mol and a PDI less than 1.5; a M_{N} between 50,000 g/mol and 100,000 g/mol and a PDI less than 1.5; a M_{N} between 100,000 g/mol and 200,000 g/mol and a PDI less than 1.5; a M_{N} between 200,000 g/mol and 500,000 g/mol and a PDI less than 1.5; a M_{N} between 400,000 g/mol and 800,000 g/mol and a PDI less than 1.5; a M_{N} between 20,000 g/mol and 50,000 g/mol and a PDI less than 2.0; a M_{N} between 50,000 g/mol and 100,000 g/mol and a PDI less than 2.0; a M_{N} between 100,000 g/mol and 200,000 g/mol and a PDI less than 2.0; a M_{N} between 200,000 g/mol and 500,000 g/mol and a PDI less than 2.0; a M_{N} between 400,000 g/mol and 800,000 g/mol and a PDI less than 2.0; a M_{N} between 20,000 g/mol and 50,000 g/mol and a PDI less than 2.5; a M_{N} between 50,000 g/mol and 100,000 g/mol and a PDI less than 2.5; a M_{N} between 100,000 g/mol and 200,000 g/mol and a PDI less than 2.5; a M_{N} between 200,000 g/mol and 500,000 g/mol and a PDI less than 2.5; a M_{N} between 400,000 g/mol and 800,000 g/mol and a PDI less than 2.5; a M_{N} between 20,000 g/mol and 50,000 g/mol and a PDI less than 3; a M_{N} between 50,000 g/mol and 100,000 g/mol and a PDI less than 3; a M_{N} between 100,000 g/mol and 200,000 g/mol and a PDI less than 3; a M_{N} between 200,000 g/mol and 500,000 g/mol and a PDI less than 3; or M_{N} between 400,000 g/mol and 800,000 g/mol and a PDI less than 3. The PDI in each of the listed examples of molecular weight ranges can be above 3.0 up to about 20.0, about 10.0 or about 6.0.

### Reaction Conditions

The monomers may be contacted with the zwitterionic initiator in a solvent; which may comprise polar non-protic solvents, such as amides, nitriles, and sulfoxides, protic liquids such as water or alcohols, ethers, esters, ketones or an aliphatic or aromatic hydrocarbons, halogenated hydrocarbons, or fluorinated hydrocarbons. The solvent may comprise a C₄₋₁₂ aliphatic hydrocarbon, an ether or a chlorinated hydrocarbon. The solvent may comprise, an ether petroleum ether, isobutane, pentanes, hexanes, or heptanes, or higher aliphatic hydrocarbons. The solvent may be comprised of isobutane or hexane. The solvent may be substantially anhydrous. The solvent may comprise an ether selected from tetrahydrofuran, 1,4 dioxane, 1,3-dioxane, dimethoxyethane, diglyme, triglyme, tetraglyme, 1,3 dioxolane, t-butylmethyl ether, and diethyl ether. The solvent may comprise tetrahydrofuran which may be anhydrous.

The methods may comprise contacting monomers with the zwitterionic initiator without a solvent. The polymerization may be conducted in neat monomers. The monomers may be contacted in a solvent system in which the zwitterionic initiator is not soluble. The method may comprise contacting the comonomers with a suspension of solid particles comprising a zwitterionic initiator. The method may comprise contacting neat monomers, with solid particles comprising a zwitterionic initiator wherein the solid particles are insoluble in the neat monomers.

The method may comprise contacting the monomers with a micelle-forming zwitterionic initiator. The reaction mixture may contain micelles formed from a plurality of zwitterionic molecules. Micelle-forming zwitterionic initiators are described in more detail hereinafter. The micelles may be suspended in a suitable solvent. The suspension of micelles may be fed into a polymerization mixture. The methods may comprise forming such micelles directly in neat monomers. The zwitterionic initiator used for such methods may comprise a hydrophobic moiety (as more fully described hereinbelow) and the initiator forms micelles when dispersed in a polar liquid medium. The method may comprise contacting the monomers with a composition containing micelles comprising a zwitterionic initiator in a polar solvent.

A gas containing BPL vapor may be contacted with solid particles comprising a zwitterionic initiator. The gas comprising monomer vapor may comprise a mixture of monomers with air or an inert gas such as nitrogen or argon. The solid particles may be suspended in a flow of such a gas. The particles are separated from the gas flow as they gain mass due to polymer formation. Additional initiator particles may be added to the gas flow (either continuously or in discrete portions) to replace particles separated from the stream. The gas stream may be maintained at a sub-atmospheric pressure and/or an elevated temperature.

The zwitterionic initiator and the monomers may be contacted at low temperatures ambient temperatures or elevated temperature. The mixture may be maintained at a temperature of about 30° C. or greater, about 40° C. or greater, about 50° C. or greater, about 60° C. or greater, about 70° C. or greater, about 80° C. or greater, about 100° C. or greater or about 120° C. or greater. The mixture may be maintained at a temperature of about 100° C. or less or about 120° C. or less. The mixture may be maintained at a temperature below about 20° C., below about, 15° C. below about 10° C., below about 5° C., below about 0° C., below about −10° C. or below about −20° C. The method may include the step of removing heat from the mixture to maintain the desired temperature. The method may include changing the temperature of the polymerization mixture during the process. The method may include the step of cooling the mixture to maintain the desired temperature. The method may include changing the temperature of the polymerization mixture over time during the process.

The polymerization may be conducted at elevated pressure. This can allow processes to be conducted at temperatures above the boiling point of certain reaction mixture components (e.g., solvents and monomers) and/or may aid in separation of volatile components when the pressurized process stream or reaction vessel is depressurized. The monomers may be contacted with a zwitterionic initiator at a pressure above 1 bar, about 2 bar or greater, about 3 bar or greater, about 5 bar or greater, about 10 bar or greater, about 15 bar or greater, about 20 bar or greater, about 30 bar or greater or about 40 bar o greater. The pressure may be about 50 bar or less, about 60 bar or less, about 70 bar or less, about 80 bar or less, about 90 bar or less or about 100 bar or less. The pressure may be applied by pressurizing a reactor headspace in contact with the reaction mixture (e.g., by introducing a pressurized inert gas). The pressure may be applied by heating the mixture in contained volume. The pressure may be controlled by application of a back-pressure regulator or other pressure relief system The pressure may be maintained by applying pressure to a hydrostatically filled reaction vessel. Two or more of these approaches may be used.

The methods provided herein can be performed in a batch process, continuous process, a hybrid of batch and continuous processes (e.g., fed batch reactions). The method may comprise the step of feeding one or more components to the polymerization mixture over time. Monomers, oligomers, end capping agents, chain extenders, chain transfer agents, or crosslinking agents may be added to the polymerization mixture over time (either continuously, or in one or more discrete additions). The composition of monomers added to such a fed reaction may be changed over time. The polymer composition produced comprises a tapered copolymer or block copolymer.

### Quenching

The disclosed methods may comprise a step of quenching the polymerization reaction. A quenching agent may be added after a specified reaction time, or when the polymer composition has reached a desired molecular weight (e.g., when the Mn of the formed polymer composition exceeds a predetermined threshold). The quenching agent may be added when a targeted portion of the monomer(s) have been consumed or when the desired molecular weights are achieved. Where the method comprises a continuous process utilizing a plug-flow reactor, a quenching agent may be added at a particular point along the length of the reactor. The quenching agent may be one or more of mineral acids, organic acids, and acidic resins or solids. The quenching agent may be HCl, H₂SO₄, RSO₃H, HBr, H₃PO₄, an acidic resin, or an acidic inorganic solid. The quenching agent may be a sulfonic acid derivative, boric acid or a boric acid derivative, phosphoric acid or a phosphoric acid derivative. The quenching agent may be a sulfonic acid. The sulfonic acid has the formula R^{q}SO₃H, wherein R^{q} is a radical selected from the group consisting of optionally substituted aliphatic, optionally substituted aryl, optionally substituted heterocyclic, and optionally substituted heteroaryl groups. Rq may be a radical selected from optionally substituted C₁ to C₂₀ alkyl, C₁ to C₂₀ alkenyl, and an optionally substituted phenyl group. The sulfonic acid may be one or more of p-toluene sulfonic acid (also known as pTSA or tosylic acid), methane sulfonic acid, ethane sulfonic acid, 1-propane sulfonic acid, trifluoromethyl sulfonic acid, 4-nitrophenyl sulfonic acid, sulfoacetic acid, cumenesulphonic acid, xylene sulfonic acid, 3-amino-1-propanesulfonic acid, 2-sulfanylethanesulfonic acid, 3-hydroxy-1-propanesulfonic acid, benzenesulfonic acid, 4-hydroxybenzenesulfonic acid, cyclohexane sulfonic acid, 4-ethylbenzenesulfonic acid, 2,5-dimethylbenzenesulfonic acid, 4-methylmetanilic acid, 1-Naphthalenesulfonic acid, and perfluorooctane sulfonic acid. The quenching agent may be methane sulfonic acid, p-toluene sulfonic acid or sulfamic acid. Acids used as quenching agents may act by protonating the active chain end(s) of the polymer (e.g. to form an —OH or CO₂H group) with the anion of the acid acting as a counterion to the polymer bound cation (e.g. a covalently bound Z⁺ group arising from the zwitterionic initiator). By way of example, a polymerization method comprising contacting monomers with a zwitterionic initiator of formula Me₃N⁺(CH₂)₄CO₂⁻will lead to formation of polymer chains of structure: Me₃N⁺(CH₂)₄CO₂(CH₂CH₂CO₂)ₙCH₂CH₂CO₂⁻; if such a reaction is quenched with HCl the resulting quenched polymer composition will contain chains of formula: [Me₃N⁺(CH₂)₄CO₂(CH₂CH₂CO₂)ₙCH₂CH₂CO₂H]Cl⁻. An acidic quenching agent may be characterized in that the acid's conjugate base is substantially non-nucleophilic.

The quenching agent may be a phosphoric acid derivative having at least one acidic hydrogen atom. The phosphoric acid derivative may be selected from phosphoric acid, pyrophosphoric acid, triphosphoric acid, an alkyl derivative of phosphoric acid, pyrophosphoric acid, or triphosphoric acid, an aryl derivative of phosphoric acid, pyrophosphoric acid, or triphosphoric acid, and a mixture thereof. The quenching agent may be phosphoric acid having the formula:

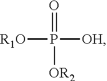

wherein, R₁ and R₂ are radicals independently hydrogen, a monophosphate, a diphosphate, an optionally substituted alkyl, an optionally substituted aryl, an optionally substituted heterocyclic, an ester derivative of a monophosphateor an ester derivative of a diphosphate group. The quenching agent may be phosphorous acid, a phosphonic acid or phosphinic derivative having at least one acidic hydrogen atom. The quenching agent may be a

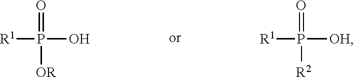

phosphonic acid or phosphinic acid having the formula: where each of R, R¹, and R² is as previously defined. The quenching agent may be a boron containing compound. The quenching agent may be fluoroboric acid.

The quenching agent may be an acid associated with a solid support. The solid supported acid may comprise an inorganic solid of silica, alumina, zirconia, titania, zeolites, metal oxides, or clays. The quenched composition forms a polymer composite with the inorganic solid quenching agent. The method may comprise adding a polymer supported acid as a quenching agent. The polymeric support may comprise a polymer derived from at least one of styrene, chloromethylated styrene and divinylbenzene monomers. The polymeric solid support may be selected from polystyrenes, poly sulfones, nylons, poly(chloromethylstyrene); polyolefins, polyacrylic acid, polymethylmethacrylate and cross-linked ethoxylate acrylate resins. Where the quenching agent comprises a solid, the method may comprise flowing a reaction stream comprising the unquenched polymer through a fixed bed of solid quenching agent. Where the method comprises, a continuous process utilizing a plug-flow reactor, a quenching agent may be added at one or more points along the length of the reactor.

### End-Capping,

The methods comprise adding an end capping agent to quench the polymerization, as disclosed in PCT application WO2019241596A1, the entirety of which is incorporated herein by reference. The monomers may be polymerized such that the terminal end of the formed polymer chains have carboxylic or carboxylate functional groups. The terminal end groups are reacted with the end capping agent. The end capping agent may render the formed polymers more stable. The end capping agents may comprise electrophilic organic compounds. The end capping agents may comprise one or more of an organohalide, organosulfonate, a haloalkyl silane, an aniline derivative, a phosphate derivative, and an isophthalic acid derivative. The electrophilic reagents cap the growing chain ends and release an anion that satisfies the charge of the covalently bound Z⁺ group. A compound R-X′ can react with an anionic chain end (e.g. to form an —OR, CO₂R group) while the liberated anion X′⁻ acts a counterion to the polymer bound cation (e.g. a covalently bound Z⁺ group arising from the zwitterionic initiator). A polymerization method comprising contacting BPL with a zwitterionic initiator of formula Me₃N⁺(CH₂)₄CO₂⁻will lead to formation of polymer chains of structure: Me₃N⁺(CH₂)₄CO₂(CH₂CH₂CO₂)ₙCH₂CH₂CO₂⁻if such a reaction is then quenched with benzyl bromide (BnBr) the resulting quenched polymer composition may contain chains of formula: [Me₃N⁺(CH₂)₄CO₂(CH₂CH₂CO₂)ₙCH₂CH₂CO₂Bn]Br⁻.

The end capping agent may comprise an alkyl halide, such as an aliphatic chloride, bromide, or iodide. The quenching agent may comprise a compound of formula Rⁿ-X^{h}, where Rⁿ is an optionally substituted C₁₋₄₀ aliphatic group and X^{h} is selected from Cl, Br, or I. The end capping agent may comprise R^{p}-CH₂-X^{h}, where R^{p} is —H or an optionally substituted radical of aliphatic, aryl, heterocyclic, and heteroaryl groups. The end capping agent may be one or more of methyl bromide, methyl iodide, allyl chloride, allyl bromide, benzyl chloride, or benzyl bromide. The end capping agent may comprise an organosulfonate. which may correspond to the formula RⁿOSO₂Rⁿ, where Rⁿ is defined above. The quenching agent may comprise methyl triflate. The end capping agent may comprise an organosulfate wherein the organosulfate may correspond to the formula RⁿOSO₂ORⁿ, where Rⁿ is as defined above. The quenching agent may comprise a dialkylsulfate, such as dimethylsulfate or diethylsulfate.

The end capping agent may be a silane, which may comprise a compound that contains a silyl or siloxy group; and may correspond to one of the formulas:

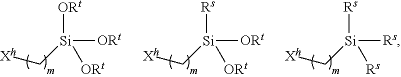

where X^{h} is as defined above, each R^{t} is methyl, ethyl or propyl, and each R^{s} is —H, chloro, methyl, or ethyl. X^{h} may be —Cl. R^{t} may be methyl or ethyl. R^{s} may be methyl. The end capping agent may comprise 6-chloropropyltrimethoxysilane.

Thermally stable aniline derivatives may be endcapping agents which may include azoles such as those selected from the group consisting of benzothiazole, benzoxazole, benzimidazole, 2-aminothiophenol, o-phenylenediamine, and 2-aminophenol.

Exemplary end-capping agents may further include phosphates such trimethylphosphate. Exemplary end-capping agents may even further include other additives and stabilizers such as isophthalic acid.

The methods may comprise a step of adding a chain extender or cross-linking agent to the polymerization reaction. The chain extender or cross-linking agent may be added as a quenching agent. When analogs of the end capping agents described above having two or more suitable reactive functional groups in a single molecule are utilized as quench agents, they may act as chain extenders or cross-linking agents respectively. Quenching with a difunctional chain extender result in reaction with the carboxylate ends of two separate polymer chains leading to the formation of a dimeric chain extended product. It will be appreciated that difunctional analogs of any of the quenching agents described above can be utilized to similar effect.

Chain extenders may comprise compounds of formula X′-L′-X′ where X′ is independently an anion as defined herein and L′ comprises a bivalent moiety. L′- may be an optionally substituted C₁-C₁₀₀ aliphatic group, - an optionally substituted C₁-C₄₀ aliphatic group; an optionally substituted C₁-C₂₄ aliphatic group, an optionally substituted C₁-C₂₀ aliphatic group, an optionally substituted C₁-C₁₂ aliphatic group, an optionally substituted C₂-C₁₀ aliphatic group; an optionally substituted C₄-C₈ aliphatic group, an optionally substituted C₄-C₆ aliphatic group, an optionally substituted C₂-C₄ aliphatic group, an optionally substituted C₁-C₃ aliphatic group, an optionally substituted C₆-C₁₂ aliphatic group or an optionally substituted C₁, C₂, C₃, C₄, C₅, C₆, C₇ or C₈ aliphatic group.

L′- may be an optionally substituted straight alkyl chain or optionally substituted branched alkyl chain. L′- may be a C₁ to C₂₀ alkyl group having one or more methylene groups replaced by -C(R^{a}R^{b})- where R^{a} and R^{b} are each independently C₁-C₄ alkyl groups. L′- may be an aliphatic group having 2 to 30 carbons including one or more gem-dimethyl substituted carbon atoms. L′- may include one or more optionally substituted rings such as saturated or partially unsaturated carbocyclic, saturated or partially unsaturated heterocyclic, aryl, and heteroaryl. L′- may be a substituted ring (i.e. the X′ groups are directly linked to atoms composing the ring in -L′-). The ring may be part of a L′- moiety having one or more non-ring heteroatoms or optionally substituted aliphatic groups separating one or more of the X′ group(s) from the ring. L′- may contain one or more heteroatoms in its main chain (i.e. in the group of covalently linked atoms separating the site(s) of attachment of the -X′ groups). L′- may comprise a moiety corresponding to the structure resulting from replacing one or more sp² carbon atoms of an optionally substituted C₄-C₄₀ aliphatic moiety with a group selected from: —O—, —NR¹—, —S—, —S(O)—, —S(O)₂—, —OC(O)—, —OC(O)O—, —NR¹C(O)O—, —NR¹C(O)NR¹—, —N═N—, —NR¹C(N)NR¹—, —SC(O)—, —SC(O)S—, —SC(S)S—,—NR¹C(O)S—, and —NR¹C(S)O—, where R¹ is as defined above and in the genera and subgenera herein and with the proviso that the -L′- moiety resulting from such replacements have a structure consistent with the recognized principles defining the structures of stable organic molecules. Where more than one such substitution is present, they are separated by at least one aliphatic carbon atom, at least two aliphatic carbon atoms. L′- may comprise one or more ether linkages, ester linkages, urethane linkages and/or amide linkages. L′- may comprise an oligomer or a polymer. The polymer may be one or more of polyolefins, polyethers, polyesters, polycarbonates, polyamides, and polyimides. Where -L′- comprises a polymer, the X′ groups may be present on the ends of the polymer chains.

If a tri-functional or higher-functional end-capping agent is utilized, a star or comb polymer composition may be obtained. Such end-capping agents may have a formula X′-L″-X′ where X′ is as defined above and herein and L″ is a multivalent linker having any of the formulae enumerated for L′ but having three or more sites available for the covalent attachment of X′ functional groups. L″ may have 3 to about 50 or more X′ groups attached. L″ may have 3 or 4 to 6 attached X′ groups. L″ may comprise a polymer that has a large number (i.e. dozens or hundreds) of attached X′ groups (as for example if the X′ groups are present as substituents on monomers comprising a polymer L″).

The quenching, end capping, crosslinking agent or chain extending agent may be added to the reaction mixture in an amount of less than 10 molar equivalents relative to the amount of zwitterionic initiator added to the polymerization process, for example from 0.1 to 10 molar equivalents relative to the amount of zwitterionic initiator, from 0.1 to 2 molar equivalents, or from 1 to 2 molar equivalents or about 1 molar equivalent.

### Beta Propiolactones and/or Functionalized Beta Propiolactones

Disclosed are several novel polymer systems containing beta propiolactones (BPL) and/or beta functionalized propiolactones. Beta propiolactones are also known as 3-hydroxypropionate. This disclosure relates to the use of hydroxyalkanoates. Polypropiolactone is also known as poly(3-hydroxypropionate). The disclosure is relevant to polymers referred to as poly (hydroxyalkanoates). The beta propiolactones and/or functionalized beta propiolactones can be used as tie layers between polymeric layers wherein the polymeric layers can be based on the same polymers or based on different polymers. The different polymers may be incompatible with one another. The functionalized beta propiolactones and/or beta propiolactones may be used as adhesive layers to bind polymeric structures together or to other substrates. Polymers and copolymers of beta propiolactones and/or functionalized beta propiolactones may be used as coatings or free-standing films or in multilayer coatings or films. The functional groups may react with other monomer systems to form crosslinks between polymer layers or can polymerize into formed layers of other copolymers. The beta propiolactones and/or functionalized beta propiolactones may have functional groups that improve bonding of films or coatings to substrates.

The functional groups from the functionalized beta propiolactones may provide functionality to polymers and copolymers prepared from the functionalized beta propiolactones. The functional groups may function as polymerization initiators, improve adhesion of the polymers to certain substrates or polymer systems, improve the hydrophobic or hydrophilic properties, improve the harness or scratch resistance, polymerization catalysts, and the like. Polymers and copolymers of functionalized beta propiolactones and/or beta propiolactones may function as intermediate layers in multilayer films, including such films having layers of different polymers. The polymers and copolymers of functionalized beta propiolactones and/or beta propiolactones decompose under certain circumstances and allow the other layers to be easily separated for reuse on recycling. Polymers and copolymers of functionalized beta propiolactones and/or beta propiolactones may function as intermediate layer between coatings of other polymers and a substrate. The polymers and copolymers of functionalized beta propiolactones and/or beta propiolactones decompose under certain circumstances and allow the substrate to be easily separated from the other coating layers for reuse on recycling. The polymers and copolymers of functionalized beta propiolactones and/or beta propiolactones can be used as the outside film layer or coating layer that can be decomposed or such outside layer can be functionalized to provide a desired set of properties to the structure.

Disclosed are beta-propiolactone and functionalized beta-propiolactone having the general formula:

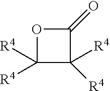

wherein R⁴ is independently in each occurrence hydrogen, a hydrocarbyl moiety or a fluorocarbyl moiety; the hydrocarbyl or fluorocarbyl moieties may optionally contain at least one heteroatom or at least one substituent. Functionalized beta-propiolactones have at least one R⁴ present as a hydrocarbyl or fluorocarbyl moiety which may enhance the function of the functionalized beta-propiolactones incorporated into polymer chains useful in coatings or films. At least one R⁴ are hydrocarbyl or fluorocarbyl groups may contain one or more of unsaturated groups, electrophilic groups, nucleophilic groups, anionic groups, cationic groups, zwitterion containing groups, hydrophobic groups, hydrophilic groups, halogen atoms, natural minerals, synthetic minerals, carbon-based particles, an ultraviolet active group, a polymer having surfactant properties, and polymerization initiators or reactive heterocyclic rings. The functional groups may be linked to the ring by a linking group (M) which functions to link the functional portion of the groups to the cyclic ring. Exemplary linking groups may be hydrocarbylene, fluorocarbylene groups, ethers, thioethers, polyethers (such as polyalkene ether). One or more of R⁴ may be a halogen substituted alkyl group, a sulfonic acid substituted alkyloxy group; an alkyl sulfonate alkyloxy group; alkyl ether substituted alkyl group; a polyalkylene oxide substituted alkyl group, an alkyl ester substituted alkyl group; an alkenyloxy substituted alkyl group; an aryl ester substituted alkyl group; an alkenyl group; a cyano-substituted alkyl group; an alkenyl ester substituted alkyl group; a cycloalkyl substituted alkyl group; an aryl group; a heteroatom containing cycloalkenyl, alkyl ether substituted alkyl group; a hydroxyl substituted alkyl group, a cycloaliphatic substituted alkenyl group; an aryl substituted alkyl group; a haloaryl substituted alkyl group; an aryloxy substituted alkyl group; an alkyl ether substituted alkaryl group; a hetero atom containing cycloaliphatic group substituted alkyl group; a hetero atom containing aryl substituted alkyl group, an alkyl amide substituted alkyl group, an alkenyl substituted cycloaliphatic group; two R⁴s may form a cyclic ring, which may optionally contain one or more unsaturated groups; an alkyl group substituted with a beta propiolactone group which may optionally be contain one or more ether groups and/or one or more hydroxyl groups; a glycidyl ether group, or a benzocyclobutenyl substituted alkyl group, optionally substituted with one or more ether groups. Beta propiolactone corresponds to the formula wherein all of the R⁴s are hydrogen. In some embodiments the R⁴s on one carbon atom are both H while both R⁴s on the other carbon atom may be an optionally substituted C₁₋₄₀ aliphatic, optionally substituted C₁₋₂₀ heteroaliphatic, optionally substituted aryl or both R⁴ groups may be optionally taken together to form an optionally substituted ring optionally containing one or more heteroatoms. One or two of the R⁴s on different carbon atoms may be methyl and the others may be hydrogen. Two R⁴s on the same carbon atom may be methyl while the other R⁴s are hydrogen.

Disclosed are homopolymers prepared from the one or more functionalized beta propiolactones or beta propiolactones described. Disclosed are copolymers of a beta propiolactone and one or more the functionalized beta propiolactones. Disclosed are compositions comprising a copolymer of one or more of the beta-propiolactones and/or functionalized beta propiolactones disclosed with one or more monomers reactive with the one or more functionalized beta propiolactones. Such copolymers include a plurality of one or more diols, difunctional poly alkyleneoxides, amine terminated polyalkylene oxides, one or more difunctional polyesters, cyclic lactones, cyclic anhydrides or polyethers. These copolymers may contain units derived from beta propiolactones. The copolymers disclosed may be block copolymers, random copolymers or one or more chains may be grafted to the polymer backbone.

### Comonomers

Disclosed are compositions comprising a copolymer of one or more of the beta propiolactones and/or functionalized beta propiolactones disclosed with one or more monomers reactive with the one or more beta propiolactones and/or functionalized beta propiolactones. Disclosed are compositions comprising a copolymer of one or more of the beta propiolactones and/or functionalized beta propiolactones disclosed with one or more monomers reactive with the one or more functionalized beta propiolactones. Such copolymers include a plurality of one or more diols, difunctional poly alkyleneoxides, amine terminated polyalkylene oxides, one or more difunctional polyesters, lactams, lactides, cyclic lactones, cyclic anhydrides, epoxides, episulfides or polyethers. Such comonomers may be one or more of epoxides, oxiranes, lactams, and lactides. The comonomer may be one or more cyclic anhydrides including succinic anhydride, methyl succinic anhydride, methyl diglycolic anhydride, methyl glutaric anhydride, maleic anhydride, phthalic anhydride, citraconic anhydride, trans-1,2-cyclohexanedicarboxylic anhydride. These copolymers may contain units derived from beta propiolactones. The copolymers disclosed may be block copolymers, random copolymers or one or more chains may be grafted to the polymer backbone.

The one or more substituted beta lactones may be:

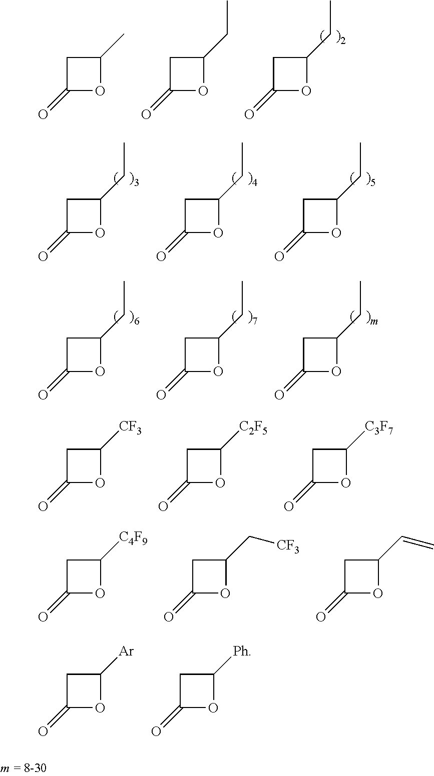

Wherein Ar is an optionally substituted aryl group and Ph is a phenyl group.

The one or more substituted propiolactones may be:

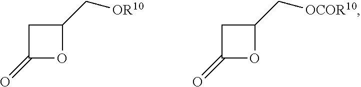

where R¹⁰ is independently in each occurrence —H, optionally substituted C₁₋₄₀ aliphatic, optionally substituted C₁₋₂₀ heteroaliphatic, and optionally substituted aryl group.

The one or more substituted propiolactones may be

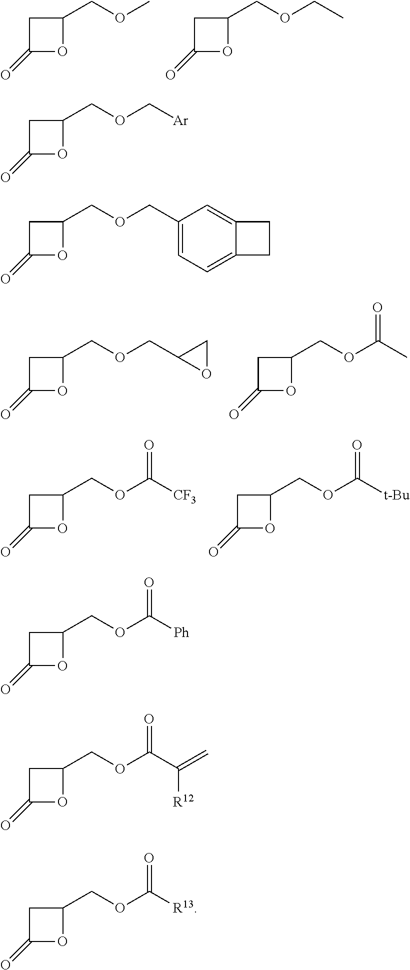

where Ar is an optionally substituted aryl group, R¹² is independently in each occurrrence —H, optionally substituted C₁₋₄₀ aliphatic, optionally substituted C₁₋₂₀ heteroaliphatic, and optionally substituted aryl, and R¹³ independently in each occurrence is a fully or partially unsaturated C₂₋₂₀ straight chain aliphatic group. The polymers may be prepared from a mixture of BPL and pivalolactone, wherein both of the R⁴s on one carbon atom are hydrogen and both of the R⁴s on the other carbon atom are substituted with methyl groups.The one or more substituted propiolactones may be:

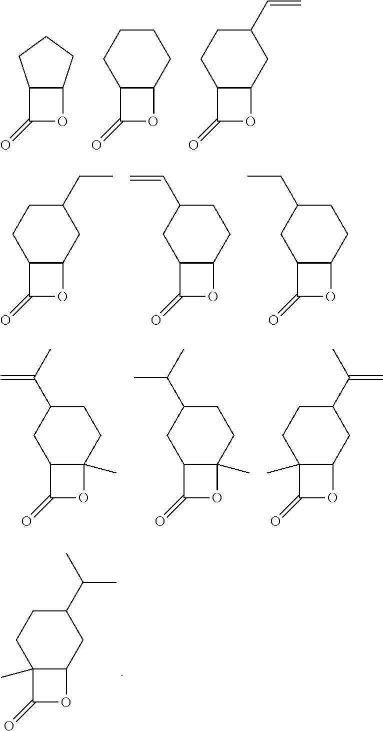

The polymers may be prepared from a mixture of BPL and a beta lactone of one of the formulas:

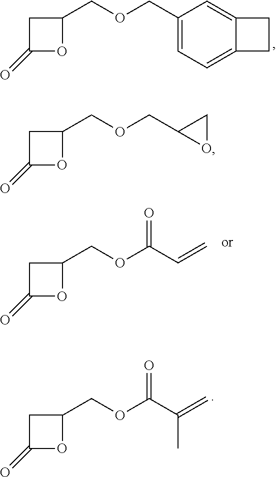 [SMILES: O=C1CC(COCc2ccc3c(c2)CC3)O1 ; O=C1CC(COCC2CO2)O1 ; C=CC(=O)OCC1CC(=O)O1 ; C=C(C)C(=O)OCC1CC(=O)O1]

The polymers may be prepared from a mixture of BPL and one or more substituted propiolactones wherein the substituted lactone is provided as a mixture of regioisomers. Any of the substituted beta lactone comonomers described above may be provided in combination with their regioisomer(s). Where a substituted beta lactone comonomer is provided as a regioisomeric mixture, the regioisomer with the largest substituent on the carbon adjacent to the ring oxygen atom is present in molar excess relative to the other regioisomer. The major regioisomer is present in a ratio of 2:1 or greater relative to the minor regioisomer of at least 3:1, at least 5:1, at least 10:1, at least 20:1, at least 30:1, at least 40:1, at least 50:1, or at least 100:1.

The polymers may be prepared from a mixture of BPL and one or more cyclic ethers including tetrahydrofuran, substituted tetrahydrofuran or epoxides. The epoxide may be a substituted epoxide, ethylene oxide, propylene oxide, butylene oxide, 4-vinylcyclohexene oxide, 4-ethylcyclohexene oxide, limonene oxide, a glycidol ether, glycidol ester or cyclohexene oxide.

The epoxides may correspond to the formula:

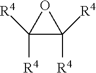

where R⁴ is as defined herein. The one or more substituted epoxides may correspond to the formula:

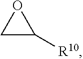

where R¹⁰ is as defined in the genera and subgenera herein. The one or more substituted epoxides may be:

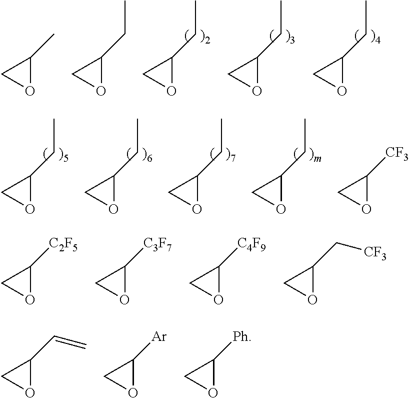

The one or more substituted epoxides may correspond to one of the formulas:

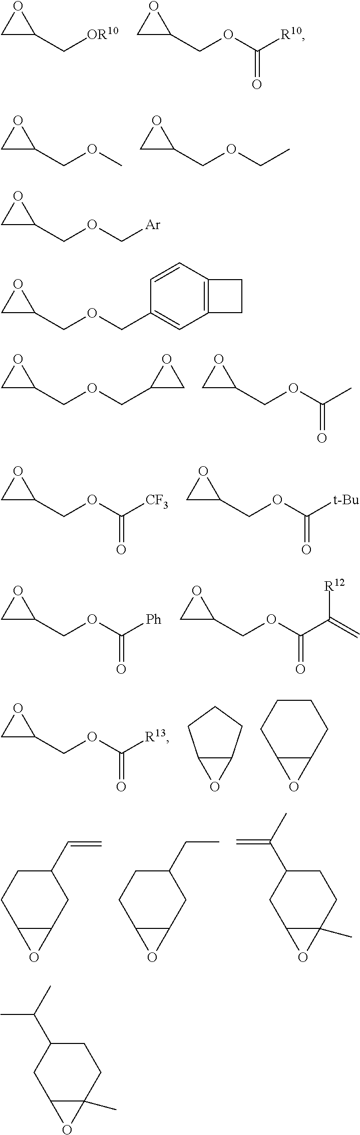

where each of Ar, R¹⁰, R¹², and R¹³ is as defined above.

The comonomer may be one or more cyclic anhydrides including succinic anhydride, methyl succinic anhydride, methyl diglycolic anhydride methyl glutaric anhydride, maleic anhydride, phthalic anhydride, citraconic anhydride, trans-1,2-cyclohexanedicarboxylic anhydride.

In methods where a co-monomer is present with the BPL, the co-monomer may be added at the beginning of the process along with the BPL, for example, a batch polymerization may be performed using a defined mixture of BPL and one or more comonomers. The methods may include changing the monomer composition over time by the addition of additional monomers to the polymerization mixture. Such additions may comprise continuous addition of BPL, comonomer(s) or mixtures of BPL and comonomers. Such additions may comprise batch-wise addition of BPL, comonomer(s) or mixtures of BPL and comonomers. Depending on the provided reaction conditions and the relative rates of polymerization of the comonomers under the conditions of the polymerization, such methods may lead to random copolymers, tapered copolymers, or block copolymers.

### Chain Transfer Agents,

The methods include the use of chain extenders, chain transfer agents, and/or crosslinking agents. The methods may comprise contacting beta propiolactone (and optional comonomers) with a zwitterionic initiator in the presence of one or more chain transfer agents. Chain transfer agents, in this context are defined as any substance or reagent capable of terminating growth of one polymer chain and initiating polymerization of a new polymer chain. In a living polymerization, this is typically a reversible process and the net effect is that, on average in the composition, all chains grow at similar rates. Chain transfer agents can be used to control the molecular weight of the produced polymer composition, to optimize the amount of catalyst used, and/or to control the polydispersity of the produced polymer composition. Chain transfer agents can also be used to introduce additional functional groups at chain ends (e.g. for subsequent cross-linking or chain extension reactions, or to impart physical properties such as hydrophilicity or hydrophobicity etc.) examples of the latter would include chain transfer agents having radically polymerizable functional groups such as vinyl groups, perfluorinated moieties or siloxy groups).

Chain transfer agents may comprise acidic compounds. Such acidic compounds may be characterized in that their conjugate bases are nucleophilic. The conjugate base of a provided acidic chain transfer agent may have sufficient nucleophilicity to ring open beta propiolactone (or to react with a provided comonomer). Exemplary chain transfer agents include carboxylic acids, sulfonic acids, phosphoric acids, phoshonic acids, phosphinic acids, thiocarboxylic acids, dithiocarboxylic acids, thiols, phenols, and the like.

Chain transfer agents (CTA) may comprise compounds of formula Y′-T-(Y′)ᵣ, where each Y′ is, independently an acidic functional group (or a salt formed by deprotonation of such a group), -T- is a multivalent moiety, and r is 0 or an integer between 1 and 10. Y′ may be, independently selected from a carboxylic acid, sulfonic acid, phosphoric acid, phoshonic acid, phosphinic acid, thiocarboxylic acid, dithiocarboxylic acid, a thiol, and a phenolic —OH group, (or an anion formed by deprotonation of any of these). The chain transfer agents may comprise molecules having more than one functional group capable of acting as chain transfer agents (e.g. dicarboxylic acids, tricarboxylic acids, etc.). The chain transfer agents may comprise carboxylic acids, such as formic acid, acetic acid, propionic acid, 3-hydroxypropionic acid, 3-hydroxybutanoic acid, lactic acid, benzoic acid, acrylic acid, and methacrylic acid. The chain transfer agent may comprise a phenol, a thiol or a derivative thereof.

The CTA may be present at the beginning of the reaction, or it may be added during the polymerization process (either continuously at a constant or variable rate, or by portion-wise addition). The CTA may be added portion-wise at one or more time points in the reaction to provide a polymer composition with a bi- or multi-modal molecular weight distribution. The CTA may be added continuously during at least part of the polymerization process to provide a polymer composition with a broadened molecular weight distribution. Where the CTA is added at the beginning of the polymerization reaction, the result is a polymer composition with a narrow PDI. The chain transfer agent may be provided at a molar ratio of from about 1:1 to about 10,000:1 relative to the zwitterionic polymerization initiator, or from about 1:1 to about 10:1, e.g. 1:1, 2:1, 3:1, 4:1, 5:1, 6:1, 8:1 or 10: lor from about 10:1 to about 100:1, e.g. 20:1, 30:1, 40:1, 50:1, 75:1, or 100:1,. about 100:1 to about 1,000:1, e.g. 200:1, 300:1, 400:1, 500:1, 750:1, or 1000:1

The polymerization methods may be integrated into a process for production of beta lactones. Such integrated processes can have advantages in terms of energy efficiency and can lead to higher quality polymer products due to reduced introduction of water, oxygen or other impurities. The methods may include a step of reacting ethylene oxide with carbon monoxide to form beta propiolactone. Exemplary catalysts and methods for such processes are described in Published Patent Applications: WO2013/063191, WO2014/004858, WO2003/050154, WO2004/089923, WO2012/158573, WO2010/118128, WO2013/063191, and WO2014/008232; in U.S. Pat. Nos. 10,662,283, 5,359,081 and 5,310,948 and in the publication “Synthesis of beta-Lactones” J. Am. Chem. Soc., vol. 124, 2002, pages 1174-1175. the entire contents of each of which is incorporated herein by reference. The methods may comprise the steps of: contacting ethylene oxide with carbon monoxide in the presence of a carbonylation catalyst and a solvent to provide reaction stream comprising beta propiolactone; separating a product stream comprising beta lactone from the reaction stream, and feeding the beta lactone-containing reaction stream into a polymerization reactor and contacting it with a zwitterionic catalyst (optionally in the presence of one or more comonomers) to provide a second reaction stream containing a biodegradable polyester. Such integrated carbonylation/polymerization processes may be characterized in that substantially all carbonylation catalyst is removed from the reaction stream comprising beta propiolactone prior to feeding the stream into the polymerization reactor. Such integrated carbonylation/polymerization processes are characterized in that at least a portion of the solvent in which the carbonylation process is performed is present in the reaction stream comprising beta propiolactone and is fed into the polymerization reactor. The method may comprise separating the solvent from the second reaction stream containing the polymer. The method may comprise recycling the separated solvent back to the carbonylation reaction. The processes may be characterized in that the reaction stream comprising beta propiolactone contains residual ethylene oxide and the beta propiolactone ethylene oxide mixture is fed into the polymerization reactor. The ethylene oxide may be a comonomer in the BPL polymerization.

### Zwitterionic Initiators

The methods described herein include a step of contacting BPL and optional comonomers with polymerization initiators that are zwitterions—e.g. polymerization initiators having at least one cation and at least one anion which are both covalently bound to a single molecule. Such zwitterions may be small molecules, or they may comprise oligomers or polymers. The zwitterionic initiators may be small molecules having a single covalently bound cation and a single covalently bound anion or may contain two or several covalently bound cations and two or several covalently bound anions. The zwitterionic initiators may comprise polymers comprising a plurality of covalently bound cations and anions. The zwitterionic initiators have an overall neutral charge (e.g. the charges of the bound cations and bound anions are equal and cancel each other) however, in certain embodiments, provided zwitterionic initiators may have an overall positive or negative charge balanced by free (e.g. by non-covalently bound) anions or cations respectively. The zwitterionic initiators may comprise essentially pure chemical compounds, or a mixture of molecules capable of functioning as zwitterionic initiators: for where the zwitterionic initiator comprises an oligomeric or polymeric structure—such compositions, may for example, comprise a statistical mixture of related molecules.

The zwitterionic initiators may have a formula: (Z⁺)ₐ-L-(X⁻)_{b}, where each Z⁺ is a cation, each X⁻ is an anion, -L- is a bond or a multivalent organic moiety covalently linked to each Z⁺ and X⁻ group, and a and b are each an integer from 1 to 20. The term multivalent in this context means the structure of the moiety -L-, when considered in isolation, has a plurality of positions where the Z+ and X− ions can be suitably attached by covalent bonds to form a stable molecular structure. For example, using this convention, a zwitterionic initiator having the formula Me₃N⁺CH₂CH₂CH₂CO₂⁻ is a compound of formula (Z⁺)ₐ-L-(X⁻)_{b} where Z⁺ is trimethylammonium, X⁻ is carboxylate, -L- is the bivalent moiety —CH₂CH₂CH₂—, and a and b are each 1.

Cationic groups (Z⁺)

The zwitterionic initiators may comprise organic “onium cations”. Such onium cations most commonly contain the heteroatoms, nitrogen, phosphorous or sulfur (or combinations of two or more of these), but other less common organocations such as stibonium or arsonium cations are also applicable.

The zwitterionic initiators may comprise a nitrogen-based onium cation which may be ammonium, amidinium, and guanidinium cations, a nitrogen-containing heterocycle such as an optionally substituted pyridinium, imidazolium, pyrrolidinium, or piperidinium. The onium cation may be:

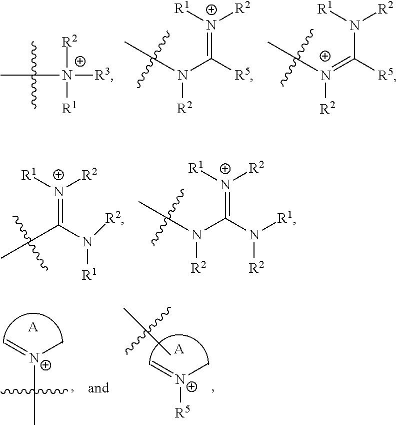

wherein: R¹, R², and R³ is, independently at each occurrence, an optionally substituted radical selected from the group consisting of: C₁₋₄₀ aliphatic; C₁₋₄₀ heteroaliphatic; phenyl; a 3- to 8-membered saturated or partially unsaturated or aromatic monocyclic carbocycle; a 7-14 carbon saturated, partially unsaturated or aromatic polycyclic carbocycle; a 5- or 6-membered monocyclic heteroaryl ring having 1-4 heteroatoms independently selected from nitrogen, oxygen, or sulfur; a 3- to 8-membered saturated or partially unsaturated heterocyclic ring having 1-3 heteroatoms independently selected from nitrogen, oxygen, and sulfur; a 6- to 12-membered polycyclic saturated or partially unsaturated heterocycle having 1-5 heteroatoms independently selected from nitrogen, oxygen, or sulfur; an 8- to 10-membered bicyclic heteroaryl ring having 1-5 heteroatoms independently selected from nitrogen, oxygen, or sulfur; and a polymer chain, wherein any two or more R¹, R², and R³ groups can optionally be taken together with intervening atoms to form one or more optionally substituted, optionally unsaturated rings optionally containing one or more additional heteroatoms; R⁵ is, independently at each occurrence, hydrogen or an optionally substituted radical selected from the group consisting of C₁₋₄₀ aliphatic; C₁₋₄₀ heteroaliphatic; a 3-to 8-membered saturated or partially unsaturated monocyclic carbocycle; a 7- to 14-membered saturated or partially unsaturated polycyclic carbocycle; a 5- to 6-membered monocyclic heteroaryl ring having 1-4 heteroatoms independently selected from nitrogen, oxygen, or sulfur; an 8- to 14-membered polycyclic heteroaryl ring having 1-5 heteroatoms independently selected from nitrogen, oxygen, or sulfur; a 3- to 8-membered saturated or partially unsaturated monocyclic heterocyclic ring having 1-3 heteroatoms independently selected from nitrogen, oxygen, or sulfur; a 6- to 14-membered saturated or partially unsaturated polycyclic heterocycle having 1-5 heteroatoms independently selected from nitrogen, oxygen, or sulfur; phenyl; an 8- to 14-membered polycyclic aryl ring; and a polymer chain; wherein two R⁵ groups or an R⁵ and one or more R¹ and/or R² groups can be taken together with intervening atoms to form one or more optionally substituted carbocyclic, heterocyclic, aryl, or heteroaryl rings; and Ring A is an optionally substituted, 5- to 10-membered ring optionally containing one or more additional heteroatoms and/or sites of unsaturation.

The cation may be quaternary ammonium cation, which may correspond to the formula f:

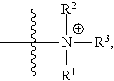

where each of R¹, R², and R³ is as defined above. Each of R¹, R², and R³ may be independently a C₁₋₂₀ aliphatic group a C₁₋₁₂ aliphatic group, C₁₋₈ aliphatic group, a C₁₋₉ aliphatic group, or a C₁₋₄ aliphatic group or methyl, ethyl, n-propyl, isopropyl, n-butyl, sec-butyl, t-butyl, 2-ethylhexyl, and C₈₋₂₀ alkyl. at least one of R¹, R², and R³ is methyl, two of R¹, R², and R³ is methyl and the third group comprises a C₂₋₂₀ alkyl chain, or R¹, R², and R³ is each methyl. one of R¹, R², and R³ may comprises a polymer chain or a hydrophobic moiety. Two or more R¹, R², and R³ groups are taken together to form a ring, such as a 5- or 6-membered saturated, or unsaturated ring optionally containing one or more additional heteroatoms. The ammonium cation may be

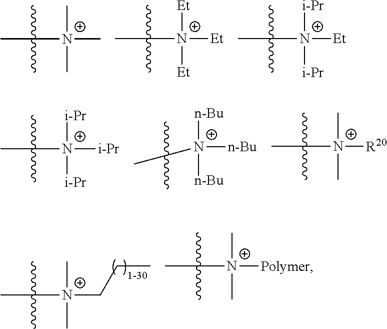

where R²⁰ is selected from optionally substituted C₂₋₄₀ aliphatic, optionally substituted aryl, optionally substituted benzyl, and a polymer chain.

The zwitterionic initiators may comprise a phosphorous-based cation. The zwitterionic initiators may comprise a phosphonium cation. The zwitterionic initiators may

comprise a phosphonium salt of formula:

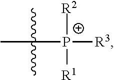

wherein each of R¹, R², and R³ is as defined above. At least one or all of R¹, R², and R³ may be an aryl group, for example phenyl. At least one of R¹, R², and R³ may be a polymer chain, the polymer chain may be linked to the phosphorous atom through an aryl ring of the phosphonium cation may be:

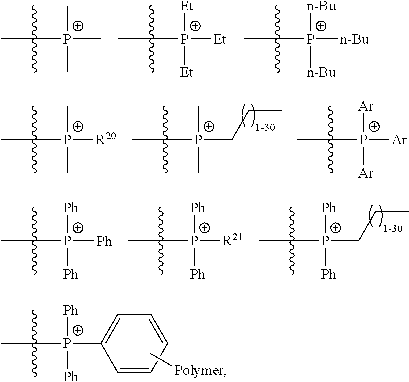

where each of Ar and R²⁰ is as defined above and in the genera and subgenera herein; and may be optionally substituted aryl, optionally substituted heteroaryl, and a polymer chain.

The cation may be an amidinium cation. The amidinium cations may be linked to the -L- moiety via the carbon atom or either of the two nitrogen atoms composing the amidinium group. All resonance forms of such cations are encompassed. The cation may be:

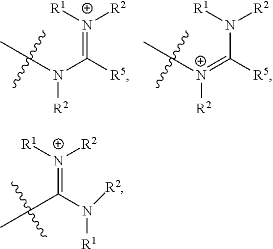

Where each of R¹, R², and R⁵ are as defined. Each of R¹, R², and R³ may be independently a C₁₋₁₂ aliphatic group, C₁₋₈ aliphatic group, a C₁₋₉ aliphatic group, or a C₁₋₄ aliphatic group. R¹, R², and R³ may be independently selected from methyl, ethyl, n-propyl, isopropyl, n-butyl, sec-butyl, t-butyl, 2-ethylhexyl, and C₈₋₂₀ alkyl. At least one of R¹, R², and R³ may be methyl. Two or more of R¹ and R² groups in such amidines may together to form a ring, such as a 5- or 6-membered saturated or unsaturated ring. The cation may be a bicyclic amidinium group, which may have one nitrogen atom bearing three nonhydrogen substituents and a second nitrogen atom with bonds to four nonhydrogen substituents. Such nonhydrogen substituents may be aliphatic substituents or the rings of the bicyclic amidinium group.

The amidinium cation may be:

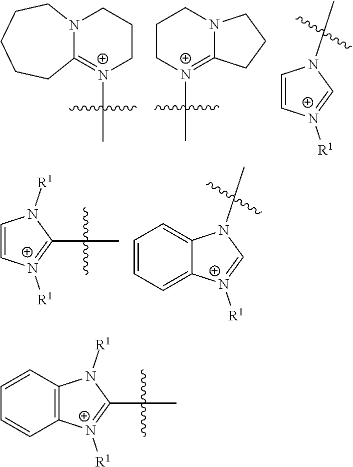

where R¹ is as defined above.

The cation may be a guanidinium cation in all resonance forms of such cations. The cations may be:

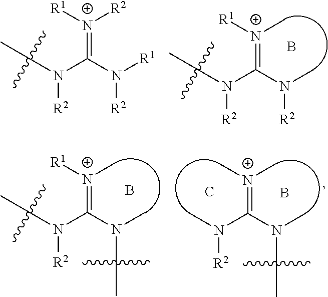

where each of R¹, R² and R⁵ is as defined above, and C and D represent 5- to 8-membered saturated or partially unsaturated rings.

The cation may be a guanidinium cation such as:

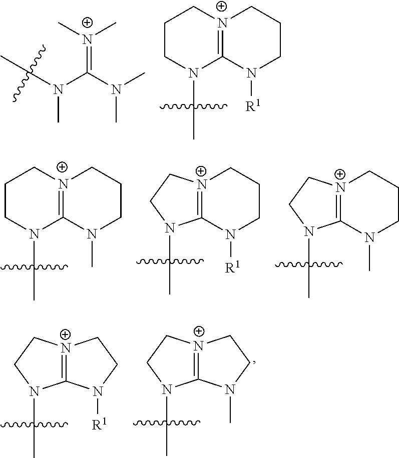

where R¹ is as defined above. Each of R¹, R², and R³ may be independently a C₁₋₁₂ aliphatic group, C₁₋₈ aliphatic group, a C₁₋₉ aliphatic group, or a C₁₋₄ aliphatic group. Each of R¹, R², and R³ may be independently selected from the group consisting of methyl, ethyl, n-propyl, isopropyl, n-butyl, sec-butyl, t-butyl, 2-ethylhexyl, and C₈₋₂₀ alkyl. At least one of R¹, R², and R³ may be methyl. Two or more R¹ and R² groups in such amidines may be taken together to form a ring, such as a 5- or 6-membered saturated or unsaturated ring. The cation may be a bicyclic amidinium group, the bicyclic amidinium groups may have one nitrogen atom bearing three nonhydrogen substituents and a second nitrogen atom with bonds to four nonhydrogen substituents. Nonhydrogen substituents may be aliphatic groups or the rings of the bicyclic amidinium group.

The cations may comprise a sulfur-based onium salt, such as a sulfonium salt. The sulfonium salt of may be:

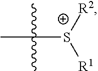

wherein each of is as defined above. R¹ and R² may each be methyl.

The cation may be a sulfoxonium cation which may be:

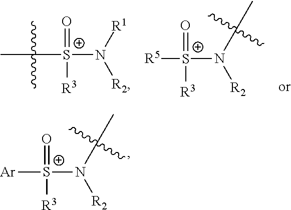

wherein each of R¹, R², R³, and R⁵ is as defined above. R¹ and R² each may be methyl. and/or R⁵ may be methyl. In this context, at least one of R³ and R⁵ may be an optionally substituted aryl group.

The cation may comprise both nitrogen and phosphorous atoms, such as a phosphazenium cation. The phosphazenium cation may be:

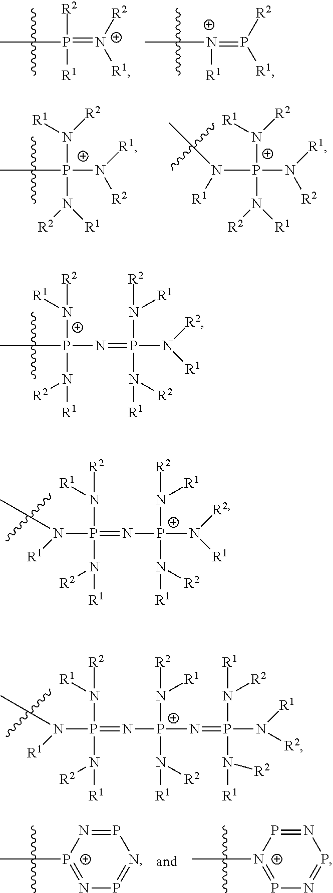

wherein each of R¹, and R² is as defined above. Each R¹ and R² group present may be methyl.

The cation may be:

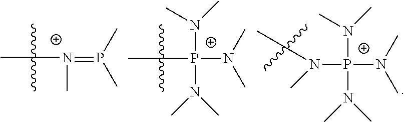

R¹, R², and R³ are each independently selected from C₁₋₄₀ aliphatic or an optionally substituted phenyl group, a C₁₋₄₀ aliphatic group, C₁₋₂₀ fluorinated aliphatic and optionally substituted aryl, a C₁₋₄₀ aliphatic group, a C₁₋₂₀ aliphatic group, a C₁₋₁₂ aliphatic group or a phenyl group, a C₁₋₁₂ aliphatic group, a C₁₋₈ aliphatic group, a C₁₋₆ aliphatic group, or a C₁₋₄ aliphatic group. R¹, R², and R³ may each be methyl, ethyl, butyl, optionally substituted phenyl group, phenyl or trifluoromethyl. Wand R², may each be methyl and R³ may be a C₁₋₂₀ aliphatic group or an optionally substituted phenyl group. At least one of R¹, R², and R³ may be a C₁₋₂₀ fluorinated aliphatic group, a C₁₋₁₂ aliphatic group, a C₁₋₈ fluorinated aliphatic group, a C₁₋₆ fluorinated aliphatic group, or a C₁₋₄ fluorinated aliphatic group, trifluoromethyl.

### Anionic Groups (X-)

The zwitterionic initiators comprise one or more covalently linked anions (e.g. X⁻groups). The anion may be an oxygen- or sulfur-based anion. The oxygen-based anion may be an anion of the formula -Q-O⁻, wherein Q comprises sulfur, phosphorous, boron or a carbonyl group. The anion, X⁻, may comprise -CO₂⁻, -SO₃⁻, -OPORO₂⁻-OPRO₂⁻, where R is selected from —H, optionally substituted C₁₋₄₀ aliphatic, optionally substituted aryl, and a polymer chain; The anion may be -CO₂⁻, -SO₃⁻, -OP(O)ORO⁻ (phosphate anion), or -PR(O)O⁻ (phosphinate anion). The anion may be a sulfur anion, X is S. The anion may be a dithiocarboxylate anion. X may be (-C(S)S⁻). -(S)ₙS⁻, where n is an integer between 1 and 20.

### Linker Groups (-L-)

A zwitterionic initiator has the formula: (Z⁺)ₐ-L-(X⁻)_{b}, where -L- is a bond, or multivalent organic moiety to which the cation(s) and anion(s) are covalently linked. The invention places no limitations on the structure of -L- and it may be any carbon-containing moiety. L- may be regarded as comprising a covalent bond—for example where the cation Z⁺ contains one or more carbon atoms which can be a site of attachment of an X⁻ group or vice versa. L- is as described hereinbefore.

L- may be an optionally substituted ring (i.e. the -Z⁺ and -X⁻ groups are directly linked to atoms composing the ring in -L-) wherein the ring may have one or more non-ring heteroatoms or optionally substituted aliphatic groups separating one or more of the Z⁺ or X⁻ group(s) from the ring. The structural constraints are built into the moiety -L- to control the disposition and orientation of the Z⁺ and X⁻ groups relative to each other. The structural constraints may be cyclic moieties, bicyclic moieties, bridged cyclic moieties and tricyclic moieties. Where-L-comprises a polymer, the Z⁺ and X⁻ groups may be present on monomers incorporated into the polymer.

### Ammonium Carboxylate Zwitterionic Initiators

The zwitterionic initiators may comprise a nitrogen containing cation and a carboxylate anion, which may correspond to a formula R¹R²R³N⁺-L-CO₂⁻ where each of R¹, R², R³ and -L- is as defined above. Such zwitterionic initiator may have a formula selected from Me₃N⁺-L-CO₂⁻, Et₃N⁺-L-CO₂⁻, i-PrEt₂N⁺-L-CO₂⁻, n-Bu₃N⁺-L-CO₂⁻, or R²⁰Me₂N⁺-L-CO₂⁻, where each of -L- and R²⁰ is as defined above.

The zwitterionic initiator may have a formula R¹R²R³N⁺-L^{a}-CO₂⁻, where L^{a} may be a C₁₋₁₀₀ optionally substituted bivalent aliphatic group and R¹, R², and R³ are as defined above. L^{a} may be a C₁₋₄₀ optionally substituted bivalent aliphatic group, a C₁₋₄₀ branched or unbranched bivalent alkyl group, a C₁₋₂₀ branched or unbranched bivalent alkyl group, a C₁₋₁₂ branched or unbranched bivalent alkyl group, a C₁₋₈ branched or unbranched bivalent alkyl group, or a C₁₋₆ branched or unbranched bivalent alkyl group; a C₁₋₂₀ straight chain bivalent alkyl group, a C₁₋₁₂ straight chain bivalent alkyl group, a C₁₋₈ straight chain bivalent alkyl group, a C₁₋₈ straight chain bivalent alkyl group, or a C₁₋₆ straight chain bivalent alkyl group. The zwitterionic initiator may have a formula selected from Me₃N⁺-L^{a}-CO₂⁻, Et₃N⁺-L^{a}-CO₂⁻, i-PrEt₂N⁺-L^{a}-CO₂⁻, n-Bu₃N⁺-L^{a}-CO₂⁻, or R²⁰Me₂N⁺-L^{a}-CO₂⁻, where each of -L^{a}- and R²⁰ is as defined above.

The zwitterionic initiators may be derived from the reaction of a tertiary amine with chloroacetic acid, bromoacetic acid or the like a zwitterionic initiator has a formula:

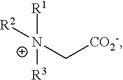

where R¹, R², and R³ are as defined above.

The zwitterionic initiator may be:

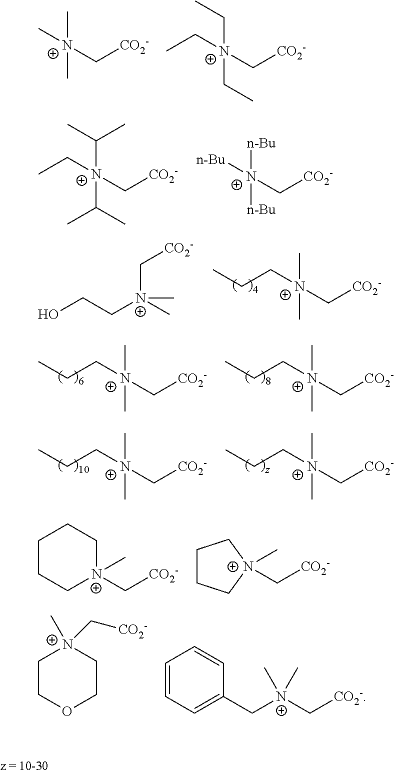

The zwitterionic initiator may be derived from an amino acid. Such reagents may be obtained by treating amino acids with alkylating agents capable of quaternizing the amine group, such zwitterionic initiators may be:

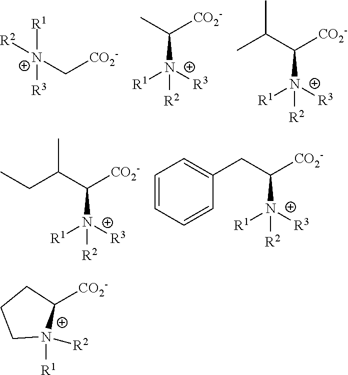

where each of R¹, R², and R³ is as defined above and in the genera and subgenera herein.

The zwitterionic initiator may be a betaine of an amino acid, which may be:

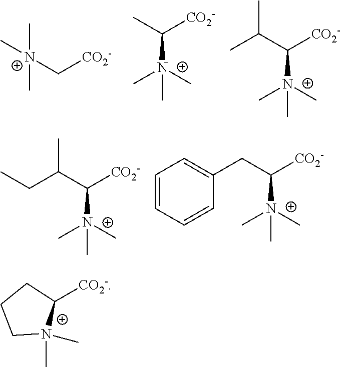

The zwitterionic initiators may be an amidinium cation and a carboxylate anion, such as:

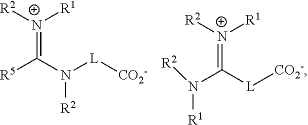

where each of R¹ and R² is as defined above.

The zwitterionic initiator may be:

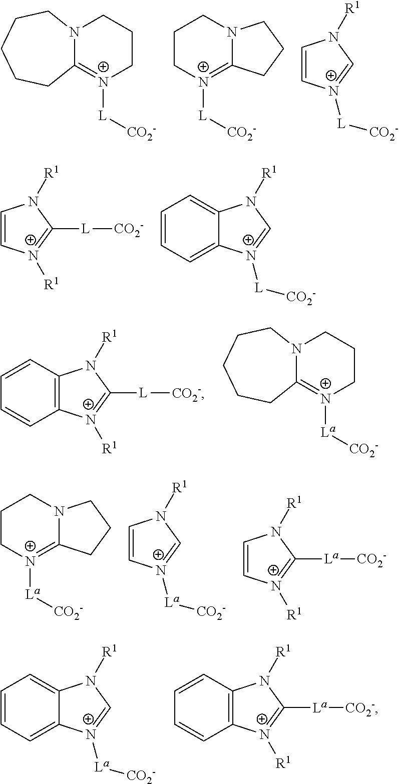

where each of L, L^{a}, R¹, R², R³, and R⁵, are as defined above.

The zwitterionic initiators may comprise a guanidinium cation and a carboxylate anion such as

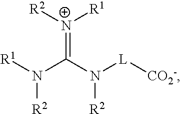

where each of R¹, R², and L is as defined above. The zwitterionic initiator may be:

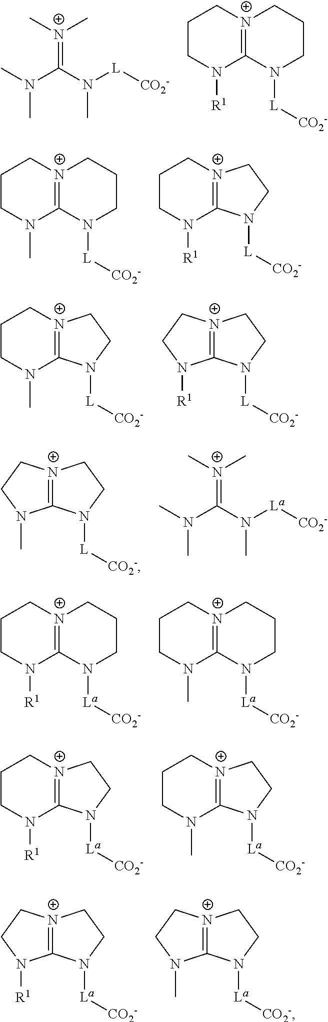

where each of L, L^{a} and R¹ is as defined above.

### Phosphonium Carboxylate Zwitterionic Initiators

The zwitterionic initiators may contain a phosphorous containing cation and a carboxylate anion. Such zwitterionic initiator may have a formula R¹R²R³P⁺-L-CO₂⁻ or R¹R²R³P⁺-L^{a}-CO₂⁻, where each of L, L^{a}, R¹, R², and R³ are as defined above and in the genera and subgenera herein. The zwitterionic initiator may be Me₃P⁺-L^{a}-CO₂⁻, Et₃P⁺-L^{a}-CO₂⁻, i-PrEt₂P⁺-L^{a}-CO₂⁻, n-Bu₃P⁺-L^{a}-CO₂⁻, Ar₃P⁺-L^{a}-CO₂⁻, Ph₃P⁺-L^{a}-CO₂⁻, or R²⁰Ph₂P³⁰ -L^{a}-CO₂⁻, where each of -L^{a}-, Ar, and R²⁰ is as defined above.

### Ammonium Sulfonate Zwitterionic Initiators

The zwitterionic initiators may comprise a nitrogen containing cation and a sulfonate anion. The zwitterionic initiator may have a formula R¹R²R³N⁺-L-SO₃⁻ or R¹R²R³N⁺-L^{a}-SO₃⁻, where L^{a}, R¹, R², and R³ are as defined above. Such zwitterionic initiator may have a formula of Me₃N⁺-L^{a}-SO₃⁻, Et₃N⁺-L^{a}-SO₃⁻, i-PrEt₂N⁺-L^{a}-SO₃⁻, n-Bu₃N⁺-L^{a}-SO₃⁻, or R²⁰Me₂N³⁰ -L^{a}-SO₃⁻, where each of -L^{a}- and R²⁰ is as defined above.

The zwitterionic initiators may comprise an amidinium cation and a sulfonate anion, which may have a formula:

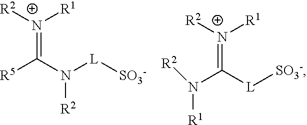

where each of R¹, R², R³, R⁵ and L is as defined above.

The zwitterionic initiator may have a formula of:

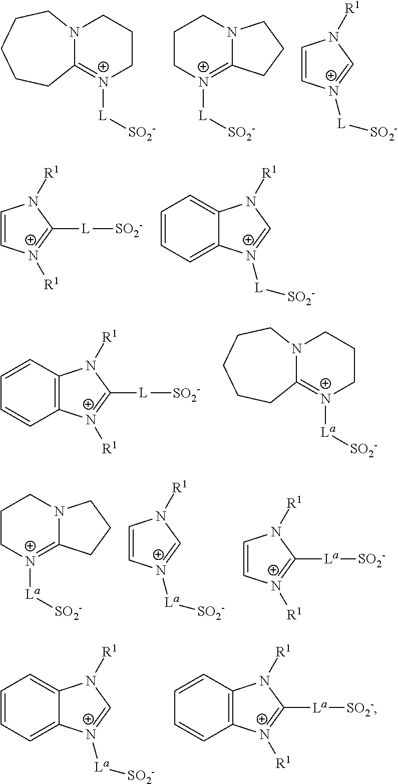

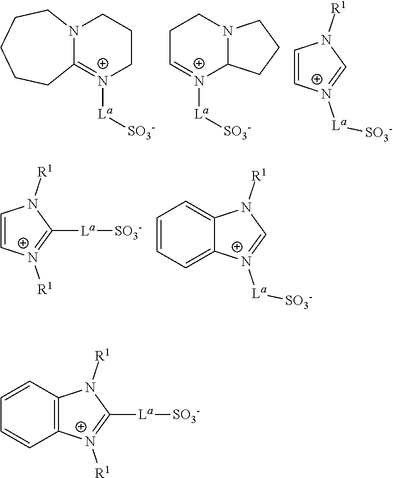

where each of L, L^{a} and R¹ is as defined above.

The zwitterionic initiators may comprise a guanidinium cation and a sulfonate anion, which may have a formula:

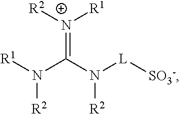

where each of R¹, R², and L is as defined above. Such zwitterionic initiators may have a formula of:

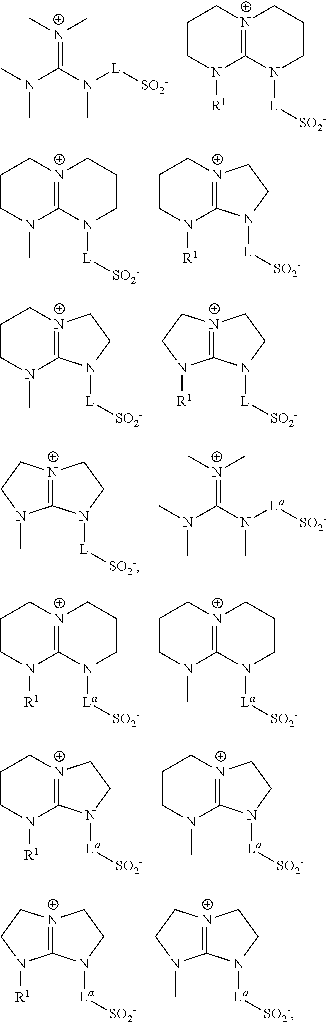

where each of L L^{a} and R¹ is as defined above.

### Phosphonium Sulfonate Zwitterionic Initiators

The zwitterionic initiators may comprise a phosphorous containing cation and a sulfonate anion. Such zwitterionic initiators may have a formula R¹R²R³P⁺-L-SO₃⁻, or R¹R²R³P⁺-L^{a}-SO₃⁻, where each of L, L^{a}, R¹, R², and R³ are as defined above. Such zwitterionic initiators may have a formula of Me₃P⁺-L^{a}-SO₃⁻, Et₃P⁺-L^{a}-SO₃⁻, i-PrEt₂P⁺-L^{a}-SO₃⁻, n-Bu₃P⁺-L^{a}-SO₃⁻, Ar₃P⁺-L^{a}-SO₃⁻, or R²⁰Ph₂P³⁰ -L^{a}-SO₃⁻, where each of -L^{a}-, Ar, and R²⁰ is as defined above.

### Ammonium Phosphate Zwitterionic Initiators

The zwitterionic initiators may comprise a nitrogen containing cation and a phosphate anion. such as those having a formula:

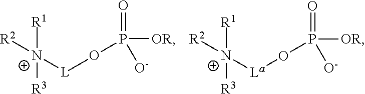

where each of R¹, R², R³, R, L, and L^{a} is as defined above. Such zwitterionic initiators may have a formula of

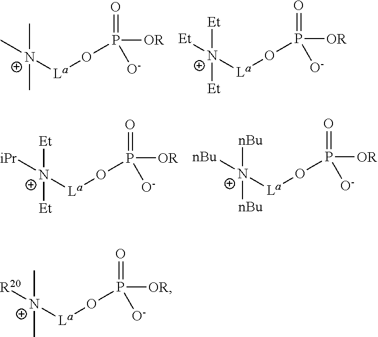

where each of L^{a}, R and R²⁰ is as defined above.

The zwitterionic initiators may comprise an amidinium cation and a phosphate anion, such as having a formula of:

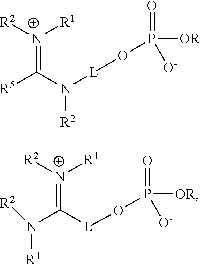

where each of R¹, R², R⁵, R and L is as defined above. Such initiators may have a formula of

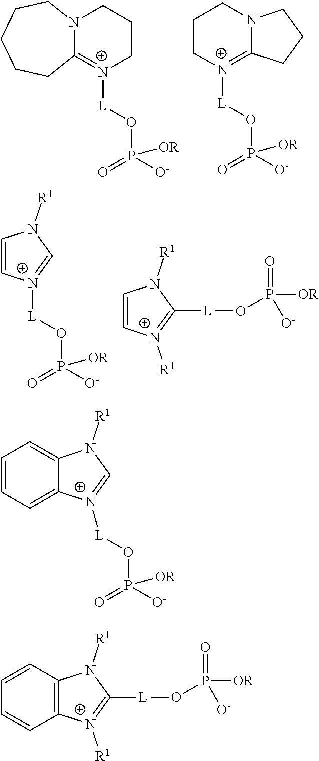

where each of R¹, R and L is as defined above.

The zwitterionic initiators may comprise a guanidinium cation and a phosphate anion, such as those of formula:

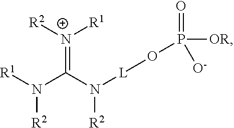

where each of R¹, R², and L is as defined above. Such initiators may be of a formula:

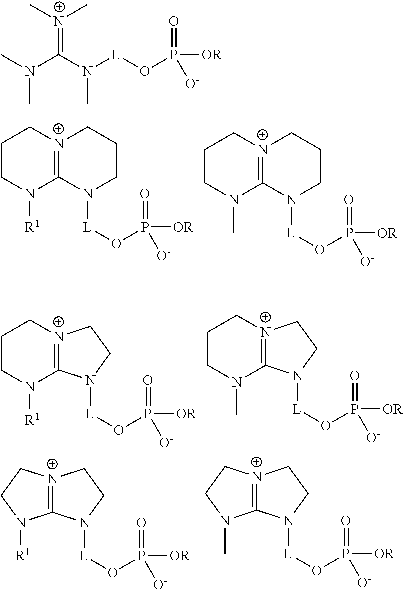

where each of R¹, R², and L is as defined above.

The zwitterionic initiator may comprise a nitrogen-based cation in combination with a phosphonate (O- or P-linked) or phosphinate anion. The zwitterionic initiators comprise the phosphonate or phosphinate analog of any of the phosphate zwitterions described above. Such initiators may have a formula of:

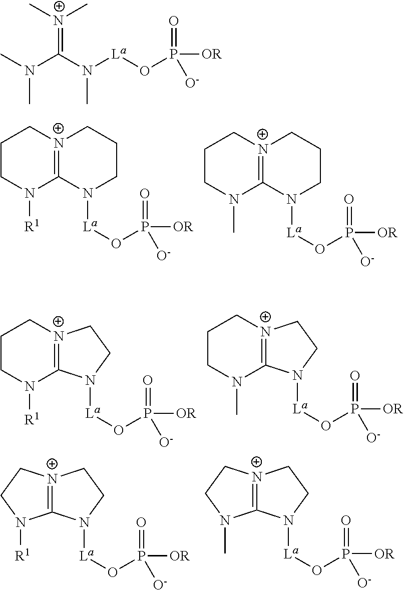

where each of R¹, R², and L^{a} is as defined above.

The zwitterionic initiators may comprise a nitrogen containing cation and a phosphonate or phosphinate anion. The zwitterionic initiators comprise an ammonium a phosphonate or an ammonium phosphinate such as:

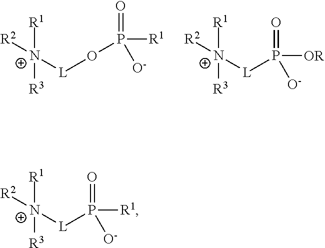

where each of R¹, R², R³, R and L is as defined above.

The zwitterionic initiators may comprise an amidinium phosphonate or an amidinium phosphinate, which may correspond to one of the formulas:

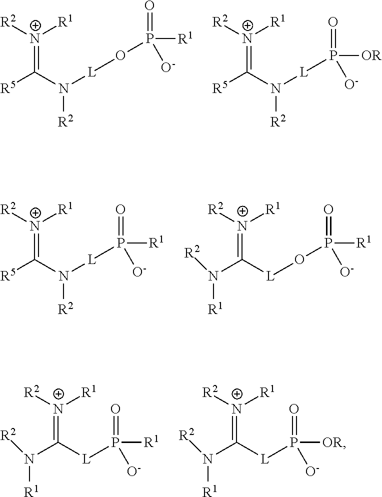

where each of R, R¹, R², R³, R and L is as defined above.

The zwitterionic initiators may comprise a guanidinium phosphonate or a

guanidinium phosphinate, which may correspond to one of the formulas:

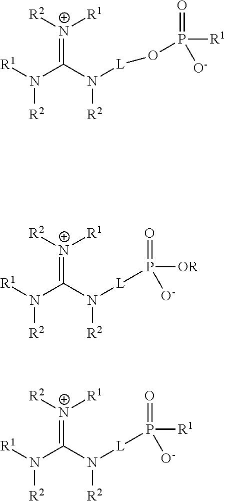

where each of R, R¹, R², R³, R and L is as defined above.

### Phosphonium Phosphate Zwitterionic Initiators

The zwitterionic initiators may comprise a phosphorous containing cation and a phosphorous containing anion, which may correspond to one of the formulas: R¹R²R³P⁺-L-OPORO₂⁻, R¹R²R³P⁺-L-OPRO₂⁻, R¹R²R³P⁺-L-PRO₂⁻, and R¹R²R³P⁺-L-PORO₂⁻, where L, R, R¹, R², and R³ are as defined above.

The zwitterionic initiator may comprise a phosphonium phosphate, which may correspond to one of the formulas R¹R²R³P⁺-L^{a}-OPORO₂⁻, where each of L^{a}, R, are as defined above or a formula selected from Me₃P⁺-L^{a}-OPORO₂⁻, Et₃P⁺-L^{a}-OPORO₂⁻, i-PrEt₂P⁺-L^{a}-OPORO₂⁻, n-Bu₃P⁺-L^{a}-OPORO₂⁻, Ar₃P⁺-L^{a}-OPORO₂⁻, pH₃p⁺-L^{a}-OPORO₂⁻, and R²⁰Ph₂P⁺-L^{a}-OPORO₂⁻, where -L^{a}-, Ar, R, R¹, R², R³ and R²⁰ are as defined.

The zwitterionic initiator may comprise an oxygen (O—) linked phosphonium phosphonate, which may correspond to one of the formulas R¹R²R³P⁺-L^{a}-OPORO₂⁻, or Me₃P⁺-L^{a}-OPORO₂⁻, Et₃P⁺-L^{a}-OPRO₂⁻, i-PrEt₂P⁺-L^{a}-OPRO₂⁻, n-Bu₃P⁺-L^{a}-OPRO₂⁻, Ar₃P⁺-L^{a}-OPRO₂⁻, pH₃p⁺-L^{a}-OPRO₂⁻, and R²⁰Ph₂P⁺-L^{a}-OPRO₂⁻, where -L^{a}-, Ar, R, R¹, R², and R³ and R²⁰ are as defined above.

The zwitterionic initiator may comprise a P-linked phosphonium phosphonate, which may correspond to one of the formulas R¹R²R³P⁺-L^{a}-PORO₂⁻, where each of L^{a}, R, or Me₃P⁺-L^{a}-PORO₂⁻, Et₃P⁺-L^{a}-PORO₂⁻, i-PrEt₂P⁺-L^{a}-PORO₂⁻, n-Bu₃P⁺-L^{a}-PORO₂⁻, Ar₃P⁺-L^{a}-PORO₂⁻, pH₃p⁺-L^{a}-PORO₂⁻, and R²⁰Ph₂P⁺-L^{a}-PORO₂⁻, where -L^{a}-, Ar, R, R¹, R², and R³ and R²⁰ are as defined above.

The zwitterionic initiator may comprise an oxygen (O—) linked phosphonium phosphinate, which may correspond to one of the formulas R¹R²R³P⁺-L^{a}-PRO₂⁻, or Me₃P⁺-L^{a}-PRO₂⁻, Et₃P⁺-L^{a}-PRO₂⁻, i-PrEt₂P⁺-L^{a}-PRO₂⁻, n-Bu₃P⁺-L^{a}-PRO₂⁻, Ar₃P⁺-L^{a}-PRO₂⁻, pH₃p⁺-L^{a}-PRO₂⁻, and R²⁰Ph₂P⁺-L^{a}-PRO₂⁻, -L^{a}-, Ar, R, R¹, R², and R³ and R²⁰ are as defined above.

The zwitterionic initiator may comprise a dithiocarboxylate anion and any of the cationic groups and linker moieties described herein. Such diothiocarboxylate zwitterions may be obtained from the 2-methyl pyridinium-, quinolinium-, and pyrimidinium- salts according to the methods described in Journal of Pharmaceutical Sciences. Volume 67, Issue 7, 1978, Pages 962-964 (1978) which is incorporated herein by reference. Such zwitterionic initiators may be:

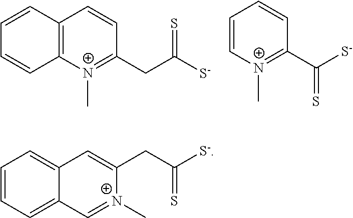

### Complexing Agents

Methods disclosed may comprise contacting monomers with a zwitterionic initiator in the presence of a complexing agent. Addition of complexing agents may improve the methods by increasing the rate of the polymerization, enhancing the yield of polymer, or may result in improved polymer properties through control of properties such as molecular weight or polydispersity. Exemplary complexing agents comprise crown ethers, and other macro polyheterocycles containing rings with a plurality of heteroatoms of —O—, —NR—, and/or —S—. Complexing agents comprise crown ethers, For example those described in the thesis titled APPLICATIONS OF CROWN ETHERS IN INDUSTRIAL ANIONIC POLYMERIZATIONS (Thomas Newton Montgomery, Jr.; Georgia Institute of Technology, December, 1977) the entire content of which is incorporated herein by reference. Exemplary complexing agents include: 1,4,7,10,13,16-hexaoxacyclooctadecane (18-crown-6); 1,4,7,10,13-pentaoxacyclopentadecane (15-crown-5) 1,4,7,10-tetraoxacyclododecane (12-crown-4), dibenzo 18-crown-6, 21-crown-7, and derivatives or mixtures of any of these. The complexing agent may comprise 15-crown-5or 12-crown-4. Crown ethers may be selected based on its ability to effectively form a complex with the cationic functional group present in the zwitterionic polymerization initiator used in the process. Complexing agents may comprise macro heterocycles comprising heteroatoms other than oxygen; crown ethers where one or more oxygen atoms is replaced by a nitrogen or sulfur atom; aza-crown ethers, such as 4,7,13,16,21-Pentaoxa-1,10-diazabicyclo[8.8.5]tricosane, 1,4,8,12-Tetraazacyclopentadecane, and 1,4,10,13-Tetraoxa-7,16-diazacyclooctadecane; or thia-crown ethers. The complexing agents may comprise those described in U.S. Pat. No. 3,890,278, the entirety of which is incorporated herein by reference. The complexing agent may be introduced at the beginning of the polymerization process, or at any later time. The complexing agent may be added at the same time as the zwitterionic polymerization initiator. The complexing agent may be provided as a mixture or solution with the zwitterionic polymerization initiator and the mixture may be fed to the reaction as described above for addition of the initiator. The complexing agent may be used, in a quantity ranging from about a 1:100 to about a 100:1 molar ratio relative to the zwitterionic polymerization initiator, 1:10 to 10:1, 1:2 to 2:1 relative to the zwitterionic polymerization initiator. The chain transfer agent may be utilized in the method, the complexing agent may be provided at a molar ratio relative to the CTA ranging from 1:10 to 10:1, 1:5 to 5:1, or 1:2 to 2:1.

### Polymer Compositions

Disclosed are polymer compositions. The polymer compositions may comprise polymer chains of formula P-I: ⁺Z-L-X-(A)-H where each of Z⁺, -L- is as defined above, -X- is a covalently bound form of the anion X⁻ as defined above; -(A)- is a polymer chain comprising poly(3-hydroxypropionate) or a copolymer comprising poly(3-hydroxypropionate) with one or more comonomers incorporated into the chain, and —H is a proton. The polymer compositions may comprise polymer chains of formula P-II: ⁺Z-L-X-(A)-R^{k}, or formula P-IIa: ⁺Z-L-X-(A)-CH₂R^{p}, where Z⁺, -L- , X, and -(A)- are as defined and R^{k} is Rⁿ or a silicon-containing functional group.

A may comprise a poly(3-hydroxypropionate) (polypropiolactone) chain which may be represented by the formula:

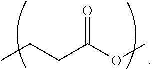

A- may comprise a copolymer of beta propiolactone with one or more comonomers as disclosed herein (A)- and may have one of the formulas:

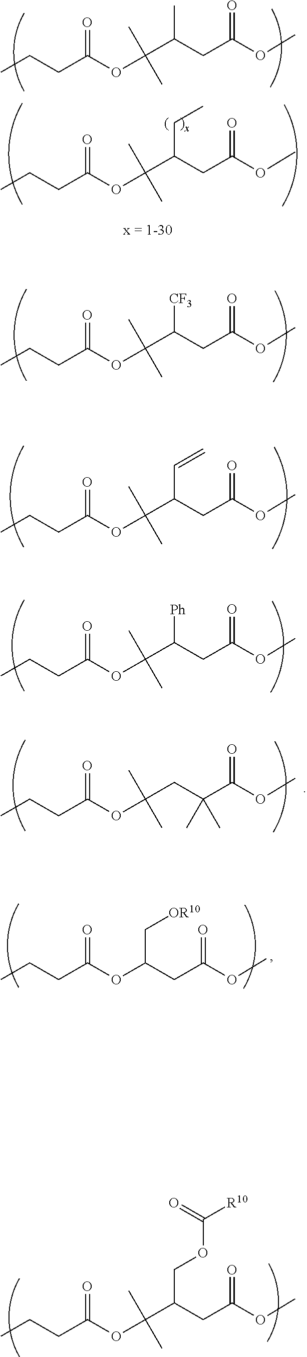

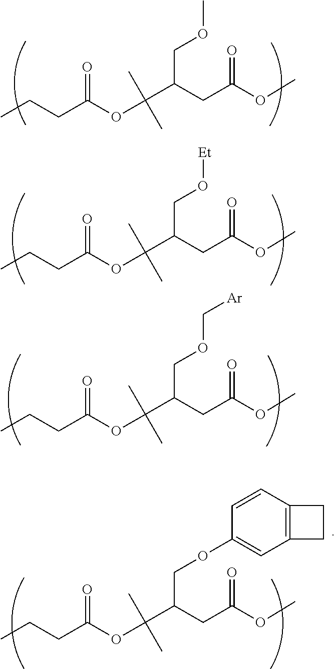

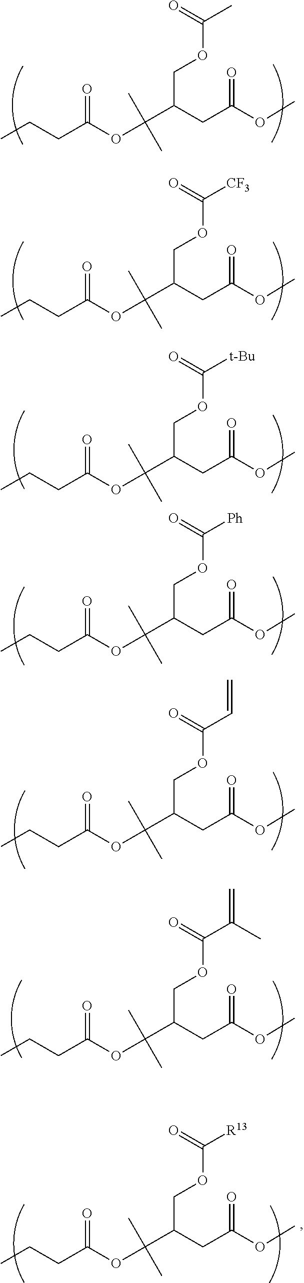

where R¹⁰ and R¹³ are as defined above.

Where -(A)- comprises a copolymer of beta propiolactone and one or more substituted beta lactones, the substituted beta lactone monomer may be present as a mixture of regioisomers. Such a copolymer may have a formula:

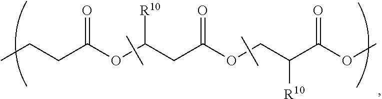

where R¹⁰ is as defined above.

The copolymers may be polymers of the propiolactone with regioisomeric mixtures of any of the substituted beta lactones described above and herein. A may comprises a copolymer of beta propiolactone and one or more epoxides, which may correspond to the formula:

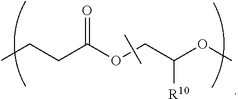

A may comprise a beta propiolactone epoxide copolymer represented by one of the formulas:

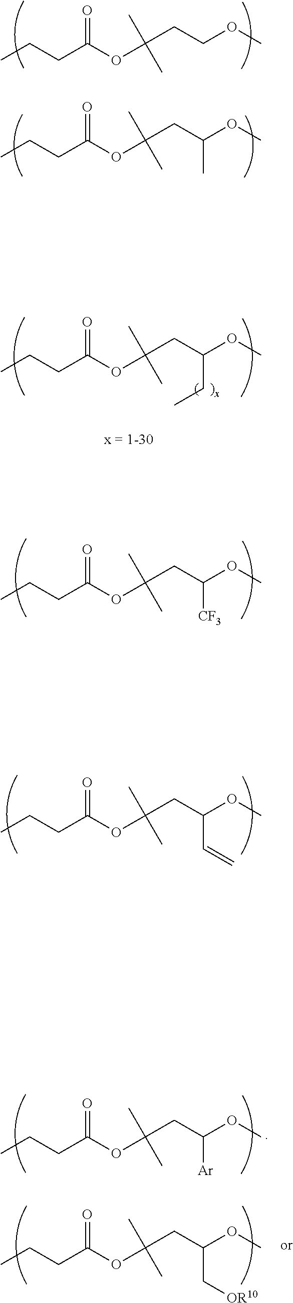

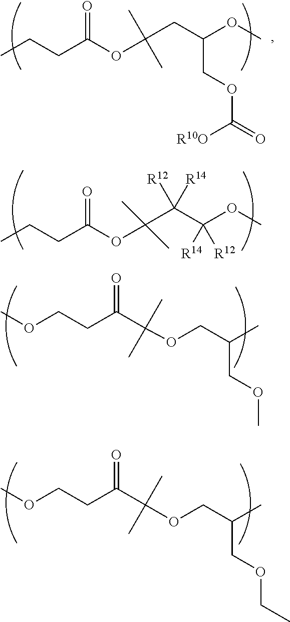

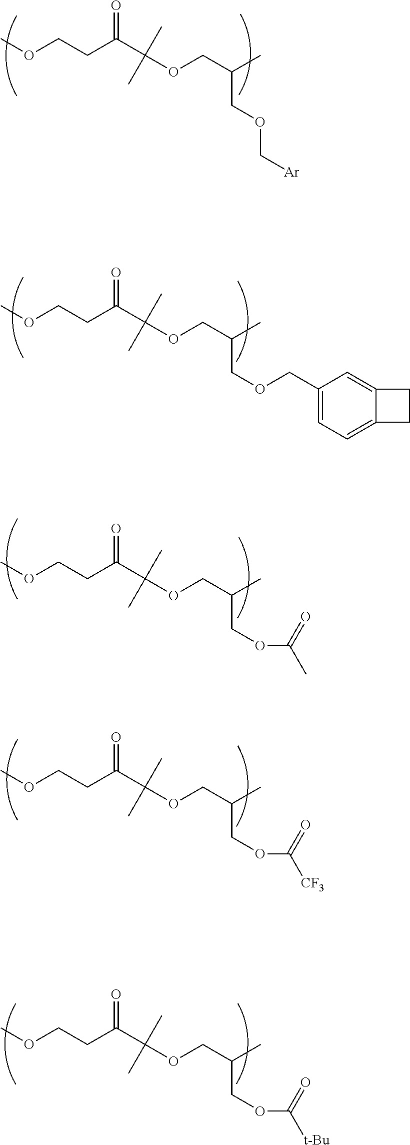

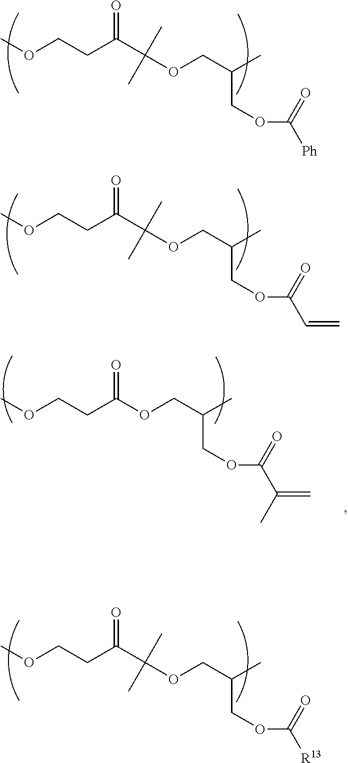

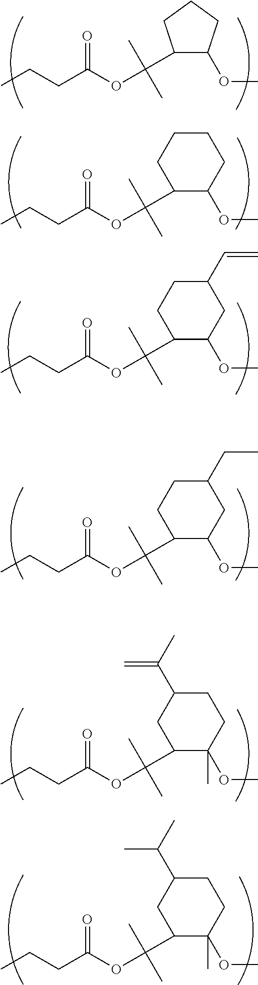

where each of R¹⁰, R¹² and R¹⁴ are as defined above

A may comprise a copolymer of beta propiolactone and lactide, which may correspond to one of the formulas

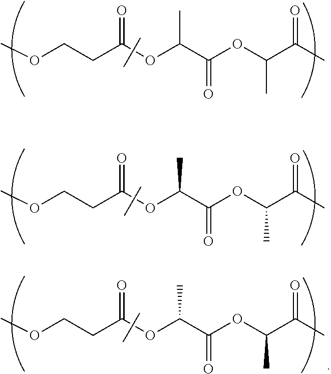

A may be a copolymer of beta propiolactone and caprolactone, which may correspond to the formula:

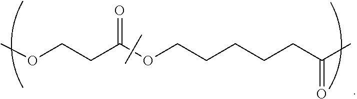

A may comprise a copolymer of beta propiolactone and two or more additional comonomers, such as any two or more of the epoxide comonomers, any two or more of the substituted beta propiolactone comonomers, at least one epoxide and at least one substituted beta propiolactone, at least one epoxide and lactide, at least one epoxide and caprolactone, at least one substituted beta propiolactone and lactide at least one substituted beta propiolactone and caprolactone, or lactide and caprolactone.

The polymer compositions comprise polymer chains having any formulae P-I, P-II, or P-IIa where the moiety ⁺Z-L-X has a formula: R¹R²R³N⁺-L-C(O)O-, where each of -L-R¹, R², and R³ is as defined above. The moiety ⁺Z-L-X may have a formula selected from Me₃N⁺-L-C(O)O-, Et₃N⁺-L-C(O)O-, i-PrEt₂N⁺-L-C(O)O-, n-Bu₃N⁺-L-C(O)O-, or R²⁰Me₂N⁺-L-C(O)O-, where each of -L- and R²⁰ is as defined above.

The moiety ⁺Z-L-X may have a formula R¹R²R³N⁺-L^{a}-C(O)O-, where L^{a} is described with the formula selected from Me₃N⁺-L^{a}-C(O)O-, Et₃N⁺-L^{a}-C(O)O-, i-PrEt₂N⁺-L^{a}-C(O)O-, n-Bu₃N⁺-L^{a}-C(O)O-, or R²⁰Me₂N⁺-L^{a}-C(O)O-, where each of -L^{a}- and R²⁰ is as defined above. The moiety ⁺Z-L-X may correspond to one of the formulas:

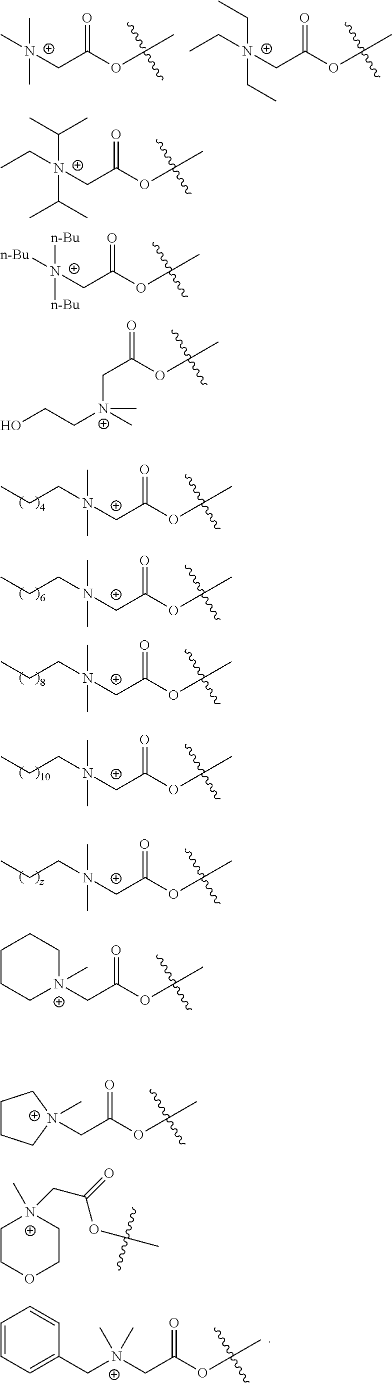

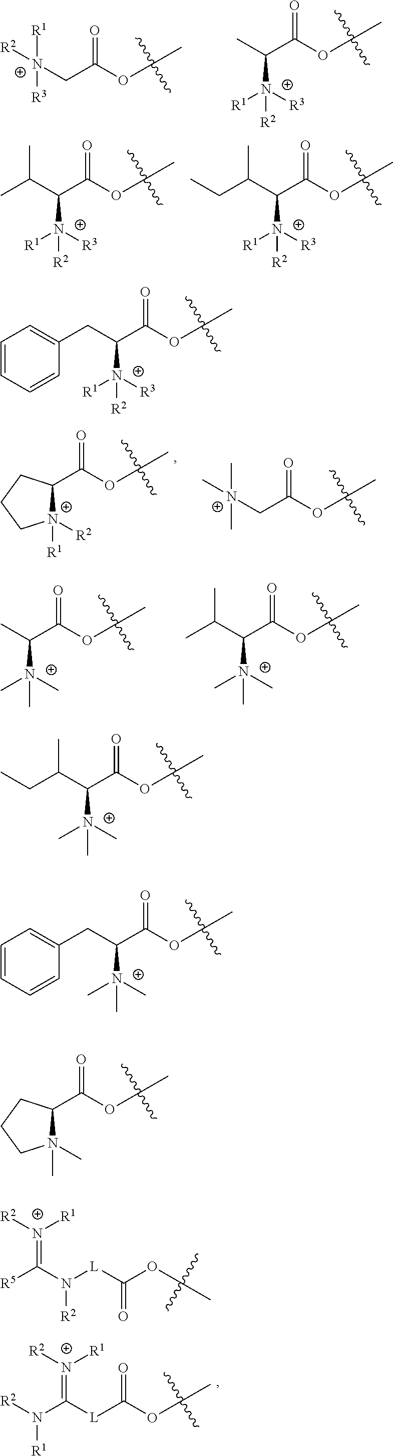

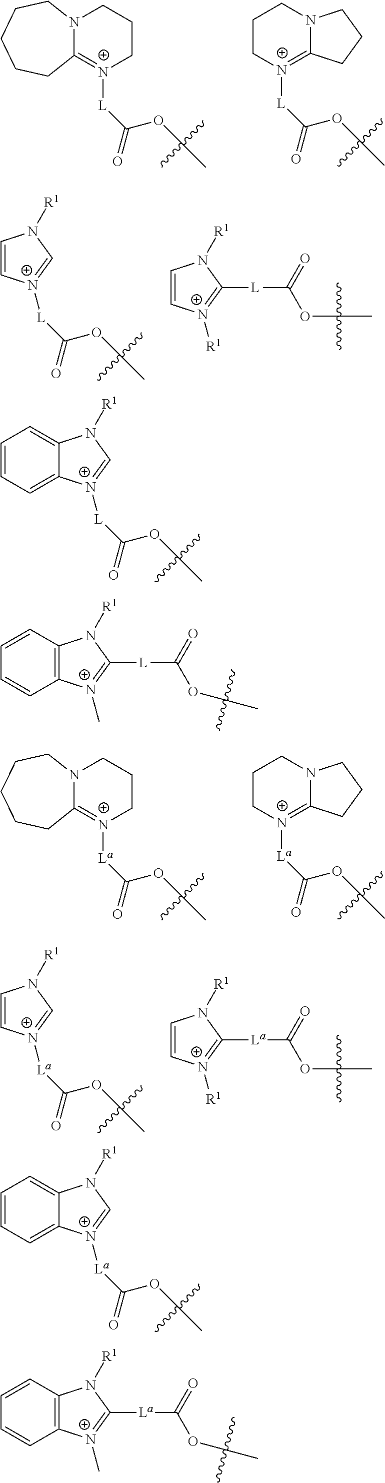

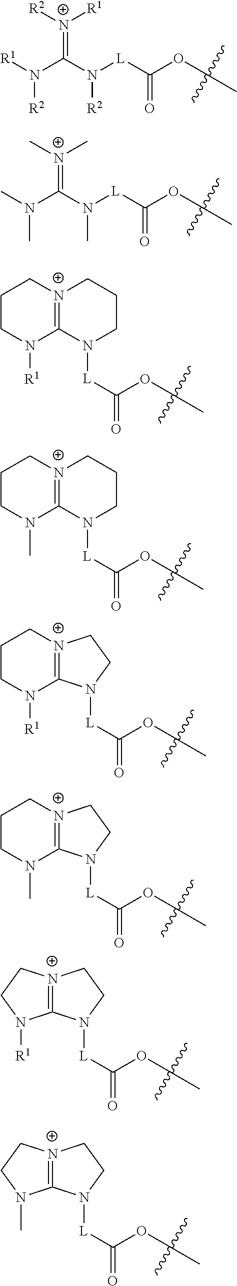

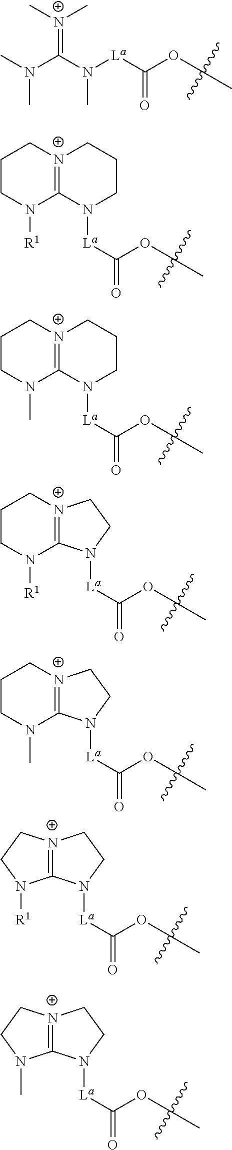

where each of R¹, R², R³, R⁵, L^{a} and L is as defined above.

The polymer compositions may comprise polymer chains having any formulae P-I, P-II, or P-IIa where the moiety ⁺Z-L-X has a formula: R¹R²R³P⁺-L^{a}-C(O)O-, where each of L^{a}, R¹, R², and R³ are as defined above or Me₃P⁺-L^{a}-C(O)O-, Et₃P⁺-L^{a}-C(O)O-, i-PrEt₂P⁺-L^{a}-C(O)O-, n-Bu₃P⁺-L^{a}-C(O)O-, Ar₃P⁺-L^{a}-C(O)O-, Ph₃P⁺-L^{a}-C(O)O-, or R²⁰Ph₂P⁺-L^{a}-C(O)O- where each of -L^{a}-, Ar, and R²⁰ is as defined above and in the genera and subgenera herein.

The polymer compositions comprise polymer chains having any formulae P-I, P-II, or P-IIa where the moiety ⁺Z-L-X has a formula: R¹R²R³N⁺-L-S(O)₂O- or R¹R²R³N⁺-L^{a}-SO₃-, where L, L^{a}, R¹, R², and R³ are as defined above. ⁺Z-L-X may be Me₃N⁺-L^{a}-SO₃-, Et₃N⁺-L^{a}-SO₃-, i-PrEt₂N⁺-L^{a}-SO₃-, n-Bu₃N⁺-L^{a}-SO₃-, or R²⁰Me₂N⁺-L^{a}-SO₃.

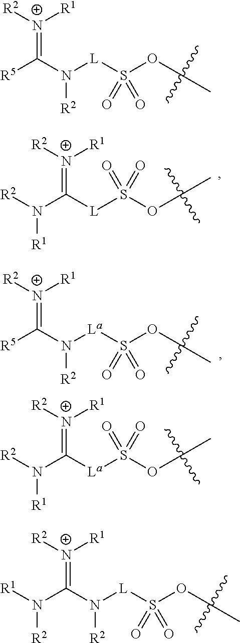

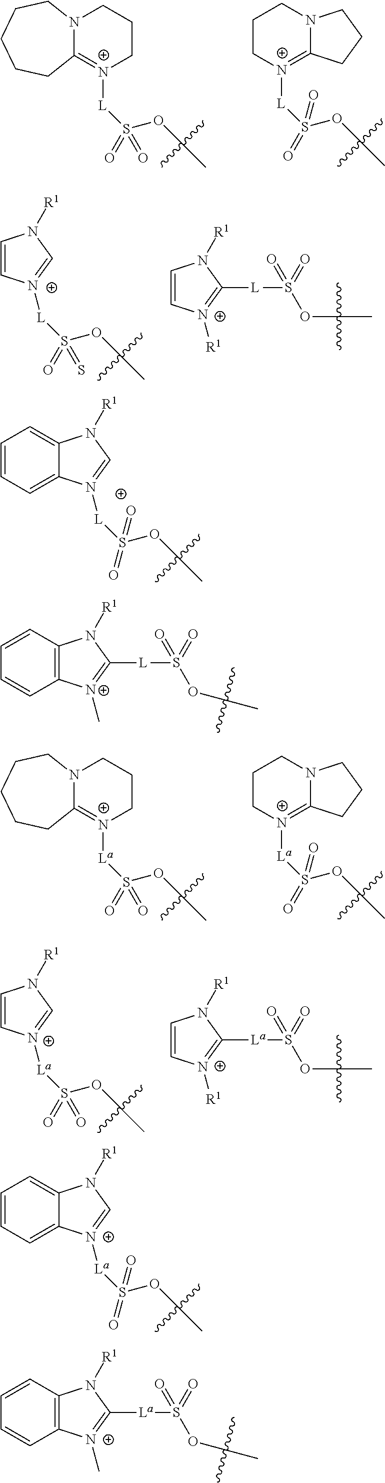

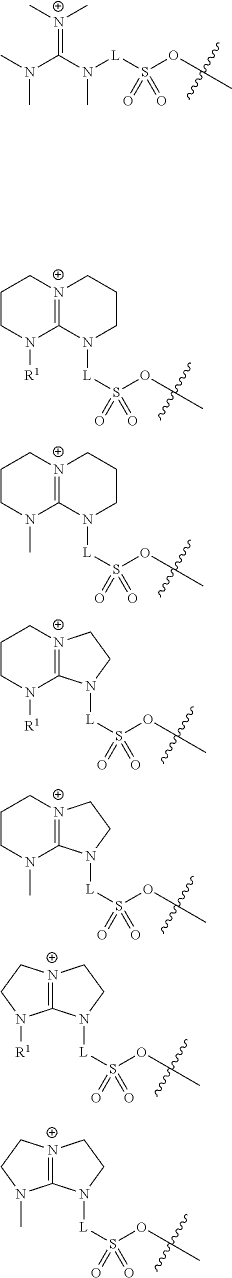

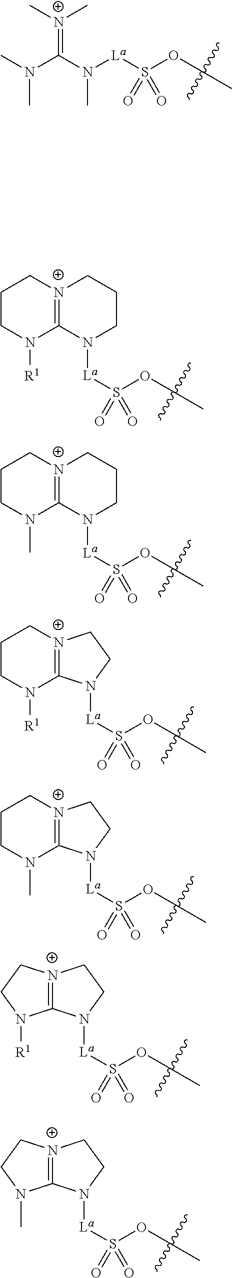

where each of R¹, R², R³, R⁵, L L^{a}- and R²⁰ are as defined above.

The polymer compositions comprise polymer chains having any formulae P-I, P-II, or P-IIa where the moiety ⁺Z-L-X has a formula: R¹R²R³P⁺-L^{a}-S(O)₂O- where each of L^{a}, R¹, R², and R³ are as defined above or Me₃P⁺-L^{a}-S(O)₂O-, Et₃P⁺-L^{a}-S(O)₂O-, i-PrEt₂P⁺-L^{a}-S(O)₂O-, n-Bu₃P⁺-L^{a}-S(O)₂O-, Ar₃P⁺-L^{a}-S(O)₂O-, Ph₃P⁺-L^{a}-S(O)₂O-, or R²⁰Ph₂P⁺-L^{a}-S(O)₂O- where each of -L^{a}-, Ar, and R²⁰ is as defined above. The polymer compositions may comprise polymer chains having any formulae P-I, P-II, or P-IIa where the moiety ⁺Z-L-X has a formula:

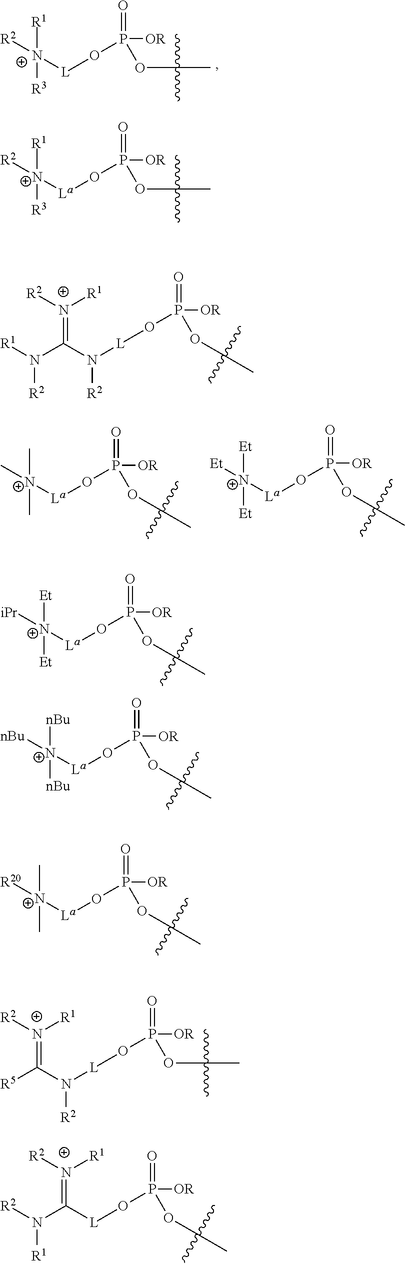

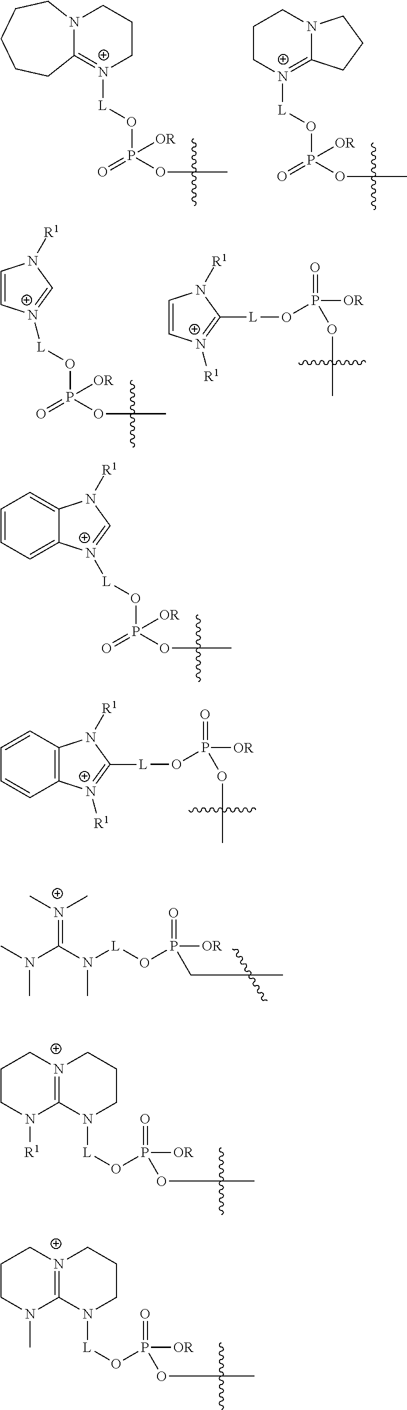

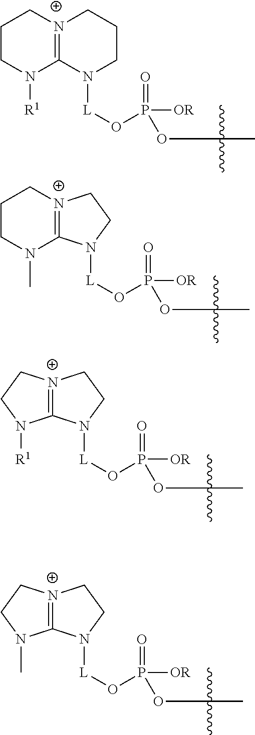

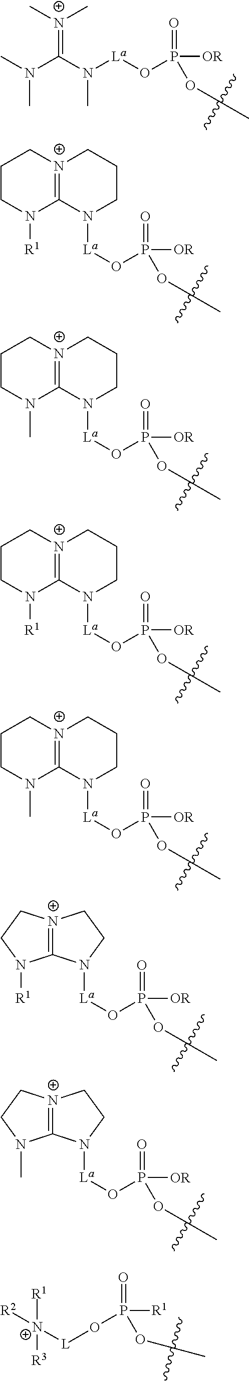

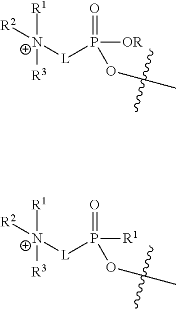

where each of R¹, R², R³, R, R²⁰ L and L^{a} are as defined above.

⁺Z-L-X may comprises an amidinium phosphonate or an amidinium phosphinate. The moiety ⁺Z-L-X may correspond to one of the formulas:

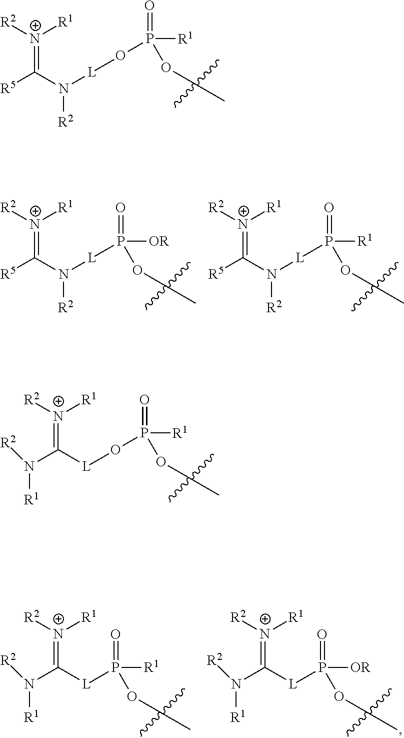

where each of R¹, R², R³, R, and L is as defined above.

⁺Z-L-X may comprise a guanidinium phosphonate or a guanidinium phosphinate. ⁺Z-L-X may correspond to one of the formulas:

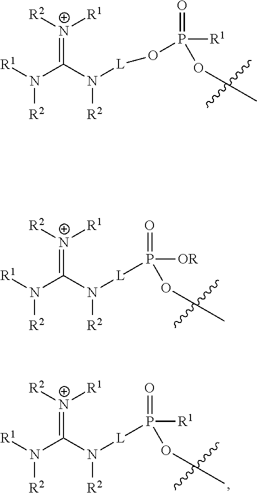

where each of R, R¹, R², R³, R, and L is as defined above.

The moiety ⁺Z-L-X may comprise a phosphorous containing cation and a phosphorous containing anion, may correspond to one of the formulas R¹R²R³P⁺-L-OPORO₂-, R¹R²R³P⁺-L-OPRO₂-, R¹R²R³P⁺-L-PRO₂-, and R¹R²R³P⁺-L-PORO₂-, where of L, R, R¹, R², and R³ are as defined above.

⁺Z-L-X may comprise a phosphonium phosphate, including those of one of the formulas R¹R²R³P⁺—L^{a}-OPORO₂-, Me₃P⁺-L^{a}-OPORO₂-, Et₃P⁺-L^{a}-OPORO₂-, i-PrEt₂P³⁰ -L^{a}-OPORO₂-, n-Bu₃P⁺-L^{a}-OPORO₂-, Ar₃P⁺-L^{a}-OPORO₂-, Ph₃P⁺-L^{a}-OPORO₂-, and R²⁰Ph₂P⁺-L^{a}-OPORO₂-, where -L^{a}-, Ar, R, R¹, R², R³ and R²⁰ are as defined above.

⁺Z-L-X- may comprises an O-linked phosphonium phosphonate, including those of one of the formulas R¹R²R³P⁺-L^{a}-OPRO₂-, Me₃P⁺-L^{a}-OPRO₂-, Et₃P⁺-L^{a}-OPRO₂-, i-PrEt₂P³⁰ -L^{a}-OPRO₂-, n-Bu₃P⁺-L^{a}-OPRO₂-, Ar₃P⁺-L^{a}-OPRO₂-, Ph₃P⁺-L^{a}-OPRO₂-, and R²⁰Ph₂P⁺-L^{a}-OPRO₂-, where f -L^{a}-, Ar, R, R¹, R², R³, and R²⁰ are as defined above.

⁺Z-L-X- may comprise a P-linked phosphonium phosphonate, including those of one of the formulas R¹R²R³P⁺-L^{a}-PORO₂Me₃P⁺-L^{a}-PORO₂-, Et₃P⁺-L^{a}-PORO₂-, i-PrEt₂P³⁰ -L^{a}-PORO₂-, n-Bu₃P⁺-L^{a}-PORO₂-, Ar₃P⁺-L^{a}-PORO₂-, Ph₃P⁺-L^{a}-PORO₂-, and where -L^{a}-, Ar, R, R¹, R², R³, and R²⁰ are as defined above.

⁺Z-L-X- may comprise an O-linked phosphonium phosphinate, including those of one of the formulas R¹R²R³P⁺-L^{a}-PRO₂-, Me₃P⁺-L^{a}-PRO₂-, Et₃P⁺-L^{a}-PRO₂-, i-PrEt₂P³⁰ -L^{a}-PRO₂-, n-Bu₃P⁺-L^{a}-PRO₂-, Ar₃P⁺-L^{a}-PRO₂-, Ph₃P⁺-L^{a}-PRO₂-, where each of -L^{a}-, Ar, R, R¹, R², R³, and R²⁰ is as defined above.

⁺Z-L-X- may comprise a dithiocarboxylate anion and any of the cationic groups and linker moieties described hereinabove, including those of one of the formulas

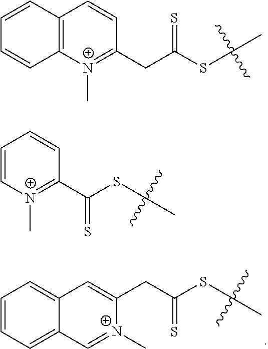 [SMILES: *SC(=S)Cc1ccc2ccccc2[n+]1C ; *SC(=S)c1cccc[n+]1C ; *SC(=S)Cc1cc2ccccc2c[n+]1C]

Disclosed are polymer compositions having an end capping agent at one end of polymer chains which may correspond to the formula P-II: ⁺Z-L-X-(A)-R^{k} where each of Z⁺, -L-, X, -(A)-, and R^{k} is as defined above. Such polymer compositions may correspond to one of the formulas: ⁺Z-L-X-(A)-OCH₃, ⁺Z-L-X-(A)-OCH₂CH₃, ⁺Z-L-X-(A)-OCH₂CH₂CH₃, ⁺Z-L-X-(A)-OCH₂CH=CH₂, ⁺Z-L-X-(A)-OCH₂Ar, and ⁺Z-L-X-(A)-OCH₂Ph, where each of Z⁺, -L-, X, -(A)-, and Ar is as defined above. Exemplary polymer compositions comprise polymer chains corresponding to one of the formulas:

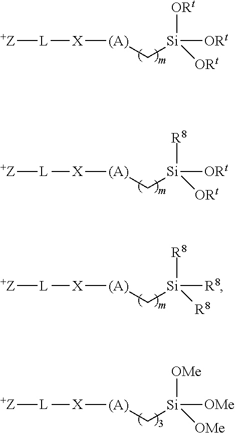

where each of Z⁺, L, -X-, (A), R^{t}, R^{s}, and in is as defined above.

The polymer compositions may comprise polymer chains which have been chain extended which may correspond to the formula: ⁺Z-L-X-(A)-L′-(A)-X-L-Z³⁰ where each of Z⁺, -L-, X, -(A)-, and L′ is as defined above and in the genera and subgenera herein. Such polymer compositions may comprise polymer chains of formula:

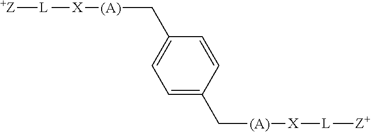

where each of Z⁺, -L-, X, and -(A)- is as defined above.

Polymer compositions containing poly functional chain extending agents may comprise polymer chains of formula: ⁺Z-L-X-(A)-L″-[(A)-X-L-Z⁺]_{g}, where g is an integer from 2 to about 50, and each of Z⁺, -L-, X, -(A)-, and L″ is as defined above. The polymer compositions may be characterized in that they comprise two or more distinct populations of polymer chains differentiated by the initiating groups present on the chains. Such a composition may arise for example where a mixture of different zwitterionic initiators is employed or when a chain transfer agent is present during the polymerization. In the former case, the resulting mixtures will comprise two or more different polymer chains will have structures conforming to formulae P-I or P-II described above. Such mixtures are specifically contemplated and disclosed herein. Mixtures of this type may be useful where the polymer bound zwitterionic initiator imparts specific characteristics (e.g. hydrophilicity, hydrophobicity, affinity for some surfaces, antimicrobial properties and the like) and there is a desire to optimize or modify such characteristics.

The second category of mixed polymer composition provided herein (i.e. arising from chain transfer) will most likely contain a population of polymer chains not conforming to formulae P-I or P-II. For example, where a CTA corresponds to formulas described herein. The polymer compositions comprise a mixture of polymer chains of formula P-I and chains of formula P-I^{C} resulting from action of chain transfer agent of formula Y′-T(-Y′)_{g}: T-[Y′-(A)-H]_{g+1}, where each T, Y′, (A), and g is as defined above (-H is a proton). Disclosed are polymer compositions comprising polymer chains of formula P-I in combination with polymer chains of formula P-I^{C} where g is 0, for example the polymer chains of formula P-I^{C} have a structure T-CO₂-(A)—H, T-SO₃-(A)-H, T-S-(A)-H (where S is a sulfur atom), T-CS₂-(A)-H T-C(S)O-(A)-H. Disclosed are polymer compositions comprising polymer chains of formula P-I in combination with polymer chains of formula P-I^{C} where g is greater than 0, for example the polymer chains of formula P-I^{C} have a structure T[-CO₂-(A)-H]_{g}, T[-SO₃-(A)-H]_{g}. (where each S is a sulfur atom or T[-CS₂-(A)-H]_{g}. , g may be 2, 3, 4, 5, or greater than 5.

Disclosed are polymer compositions comprising polymer chains of formula P-II^{C}: T-[Y′-(A)- R^{k}]_{g+1}, where each of T, Y′, (A), R^{k} and g is as defined above. The disclosed polymer compositions may comprise mixtures comprising polymer chains of formula P-II in combination with polymer chains of formula P-II^{C} where g is 0, for example T-CO₂-(A)-R^{k}, T-SO₃-(A)-R^{k} T-S-(A)-R^{k} (where S is a sulfur atom) T-CS₂-(A)-R^{k} or T-C(S)O-(A)-R^{k}. Disclosed are polymer compositions comprising mixtures comprising polymer chains of formula P-II in combination with polymer chains of formula P-II^{C} where g is greater than 0, such as T[-CO₂-(A)-R^{k}]_{g}. In certain embodiments, the polymer chains of formula P-II^{C} have a structure T[-SO₃-(A)-R^{k}]_{g}. T[-S-(A)-R^{k}]_{g} (where each S is a sulfur atom) or T[-CS₂-(A)-R^{k}]_{g}. g may be 1 2 3, 4, 5, or greater than 5

The polymer compositions may comprise mixtures of chains of formula P-I and P-I^{C}, or P-II and P-II^{C}, the compositions are characterized in that a ratio of chains P-I:P-I^{C} or P-II:P-II^{C} ranges from about 1:1 to about 1:10000. Disclosed are polymer compositions comprise mixtures of chains of formula P-I^{C} and P-I are present at a ratio of from about 1:1 to about 10:1, (e.g. 1:1, 2:1, 3:1, 4:1, 5:1, 6:1, 8:1 or 10:1) about 10:1 to about 100:1, (e.g. 20:1, 30:1, 40:1, 50:1, 75:1, or 100:1), about 100:1 to about 1,000:1, (e.g. 200:1, 300:1, 400:1, 500:1, 750:1, or 1000:1) or from about 1,000:1 to about 10,000:1, (e.g. 2,000:1, 3,000:1, 4,000:1, 5,000:1, 7,500:1, or 10,000:1).The disclosed polymer compositions may comprise mixtures of chains of formula P-II^{C} and P-II present ata ratio of from about 1:1 to about 10:1, (e.g. 1:1, 2:1, 3:1, 4:1, 5:1, 6:1, 8:1 or 10:1), about 10:1 to about 100:1, (e.g. 20:1, 30:1, 40:1, 50:1, 75:1, or 100:1), about 100:1 to about 1,000:1, (e.g. 200:1, 300:1, 400:1, 500:1, 750:1, or 1000:1) or about 1,000:1 to about 10,000:1, (e.g. 2,000:1, 3,000:1, 4,000:1, 5,000:1, 7,500:1, or 10,000:1).

In embodiments where the provided polymer compositions comprise mixtures of different polymer types, the composition may be determined directly by analytical techniques applied to the composition. Of particular use in this regard are sensitive spectroscopic techniques capable of discerning the polymer structures or polymer end groups (i.e. nuclear magnetic spectroscopy or mass spectroscopy). Alternatively, the composition may be inferred from knowledge of the feedstocks used to prepare the polymer composition (i.e. the identity and ratios of the zwitterionic initiator, chain transfer agents, and monomers employed). In some instances, fractionation or decomposition of the polymer composition may also be used to determine structural characteristics (either alone, or in combination with other analytical techniques).

### EXAMPLES

The following examples are merely illustrative and are not meant to limit any aspects of the present disclosure in any way. Addition of the strong bases generates Zwitterionic initiators in situ. Exemplary strong bases include the following.

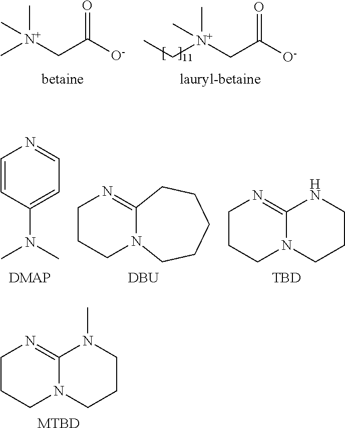

### Example 1

When betaine; 2.1 mg; 0.015 mmol), beta-propiolactone (1.15 g; 16 mmol), and THF (solvent; 13 mL) are combined in a glass vial, 100% of bPL is consumed in 24 h to yield a white polymer of P3HP precipitating from solution (Mn according to GPC is 62,400 g/mol; PDI is 3.4).

### Example 2

When betaine; 1.1 mg; 0.008 mmol), beta-propiolactone (1.15 g; 16 mmol), and THF 13 mL are combined in a glass vial, 100% of bPL is consumed in 6 h to yield a white polymer of P3HP precipitating from solution (Mn according to GPC is 108,500 g/mol; PDI is 2.9).

### Example 3

P3HP can be prepared as previously described in Example 2, but lauryl-betaine is used in place of betaine, the reaction is complete in 24 h yielding a white polymer (Mn according to GPC is 51,300 g/mol; PDI is 3.7).

### Example 4

P3HP can be prepared as previously described in Example 1, but dimethyl amino pyridine (DMAP) is used in place of betaine, the reaction is complete in 18 h yielding a white polymer (Mn according to GPC is 32,600 g/mol; PDI is 3.5). Addition of DMAP generates Zwitterionic initiators in situ.

### Example 5

P3HP can be prepared as described in Example 1, but DBU is used in place of betaine, the reaction is complete in 12 h yielding a white polymer (Mₙ according to GPC is 19,000 g/mol; PDI is 3.2). Addition of DBU generates Zwitterionic initiators in situ.

### Example 6

P3HP can be prepared as previously described in Example 1, using TBD is used in place of betaine acetate, the reaction is complete in 18 h yielding a white polymer (Mₙ according to GPC is 40,100 g/mol; PDI is 5.6). Addition of TBD generates Zwitterionic initiators in situ.

### Example 16

P3HP can be prepared as previously described in Example 1, but MTBD is used in place of betaine, the reaction is complete in 18 h yielding a white polymer (Mₙ according to GPC is 48,400/mol; PDI is 3.0). Addition of MTBD generates Zwitterionic initiators in situ.

A summary of polymer molar mass from the polymerization of beta-propiolactone with various initiators is shown in Table 1

TABLE 1
Examples of polymer molar masses from variable
initiators for beta-propiolactone.

| | | Time^{b} | M_{n[GPC]}^{c} | Mw_{[GPC]}^{c} | |
|---|---|---|---|---|---|
| Initiator | M:I^{a} | [h] | (g/mol) | (g/mol) | Ð^{c} |
| betaine | 500:1 | 24 | 51,800 | 207,200 | 4.0 |
| | 1000:1 | 24 | 62,800 | 219,800 | 3.5 |
| | 2000:1 | 24 | 108,500 | 314,700 | 2.9 |
| lauryl-betaine | 500:1 | 24 | 15,000 | 45,000 | 3.0 |
| | 1000:1 | 24 | 28,000 | 114,800 | 4.1 |
| | 2000:1 | 24 | 51,300 | 189,800 | 3.7 |
| DMAP | 1000:1 | 18 | 32,600 | 114,100 | 3.5 |
| DBU | 1000:1 | 12 | 19,000 | 60,800 | 3.2 |
| TBD | 1000:1 | 18 | 40,100 | 224,600 | 5.6 |
| MTBD | 1000:1 | 18 | 48,400 | 145,200 | 3.0 |

^{a}Monomer [M] to initiator [I] ratio
^{b}Time to reach greater than 99% conversion of the bPL in 1.1-1.8M bPL in THF solvent.
^{c}Number-average molar mass (Mₙ), weighted average molar mass (M_{w}), and dispersity (Ð = M_{w}/Mₙ) determined by CHCl₃-GPC (40° C.; 1.0 mL/min) versus PMMA standards.

The structure of zwitterionic compounds can influence the polymerization efficacy [Figure 8]. Long alkyl chains, as shown in lauryl-betaine, produces polymers with controllable molar mass, although lower than the targeted molar masses. In contrast, betaine gives high molar mass polymers regardless of the M:I ratio in the reaction. This is likely a solubility-limited process. However, betaine can be used to generate high molecular weight poly(3-hydroxypropionic acid) (Mn=108,500 g/mol) in less than 24 h in some examples.

### Other Embodiments

The foregoing has been a description of certain non—limiting embodiments of the invention. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A polymer comprising one or more polymer chains of beta propiolactone and/or substituted beta propiolactone and having on one end of the chains a residue of a zwitterion having an anion and a cation wherein the anion portion is covalently bonded to the one end of the polymer chains, wherein the ratio of beta propiolactone and/or substituted beta propiolactones to the zwitterion is from about 100 to 1 to about 1,000,000 to 1.

2. The polymer according to claim 1 wherein the one or more polymer chains have the residue of an end capping agent on the other end of the chains, wherein the end capping agent is one or more of an organohalide, organosulfonate, a haloalkyl silane, an aniline derivative, a phosphate derivative, and an isophthalic acid derivative.

3. (canceled)

4. The polymer according to claim 1, wherein the anion is an oxygen or sulfur-based anion and the cation is an organic onium cation and wherein the onium cations contain nitrogen, phosphorus, sulfur, antimony or arsenic.

5. (canceled)

6. The polymer according to claim 1, wherein the anion and cation of the Zwitterion are linked by a bond or a multivalent organic moiety.

7-9. (canceled)

10. A polymerizable composition comprising:
a. one or more of beta propiolactone and/or substituted beta propiolactones; and
b. one or more zwitterionic initiators, wherein the ratio of the one or more of beta propiolactone and/or substituted beta propiolactones to the one or more zwitterionic initiators is from 100 to 1 to 1,000,000 to 1.

11. The polymerizable composition according to claim 10 comprising one or more comonomers which copolymerize with one or more of beta propiolactone and/or substituted beta propiolactones.

12. The polymerizable composition according to claim 10 comprising one or more of chain transfer agents, chain extenders and end capping agents.

13. The polymerizable composition according to claim 10, wherein the ratio of the one or more of beta propiolactone and/or substituted beta propiolactones to the one or more zwitterionic initiators is from about 500 to 1 to about 1000,000 to 1.

14. The polymerizable composition according to claim 12, wherein the end capping agent is one or more of an organohalide, organosulfonate, a haloalkyl silane, an aniline derivative, a phosphate derivative, and an isophthalic acid derivative.

15. (canceled)

16. The polymerizable composition according to claim 11, wherein comonomers are one or more of caprolactones, lactides, epoxides, oxetanes, cyclic anhydrides, lactams, episulfides, aziridines, (meth)acrylates, valerolactones, butyrolactone and glycolides.

17-18 (canceled)

19. The polymerizable composition according to claim 10, wherein the one or more zwitterionic initiators have an anion and a cation and the anion is an oxygen or sulfur-based anion and the cation is an organic onium cation, wherein the onium cations contain nitrogen, phosphorus, sulfur, antimony or arsenic.

20. (canceled)

21. The polymerizable composition according to claim 19, wherein the anion and cation of the one or more zwitterionic initiators are linked by a bond or a multivalent organic moiety.

22. A method comprising contacting one or more of beta propiolactone and/or substituted beta propiolactones and comonomers with one or more zwitterionic initiators under conditions to prepare one or more polymers comprising one or more polymer chains having ring opened beta propiolactone and/or substituted beta propiolactone units and having on one end of the chains a residue of a zwitterion having an anion and a cation wherein the anion portion is covalently bonded to the one end of the polymer chains; the ratio of the one or more of beta propiolactone and/or substituted beta propiolactones to the one or more zwitterionic initiators is from about 100 to 1 to about 1,000,000 to 1.

23. The method according to claim 22, wherein the ratio of the one or more of beta propiolactone and/or substituted beta propiolactones to the one or more zwitterionic initiators is from about 500 to 1 to about 1,000,000 to 1.

24. The method according to claim 22 wherein the one or more of beta propiolactone and/or substituted beta propiolactones and comonomers and one or more zwitterionic initiators are contacted at a temperature of from about 0° C. to about 120° C.

25. (canceled)

26. The method according to claim 22, wherein the one or more of beta propiolactone and/or substituted beta propiolactones and comonomers and one or more zwitterionic initiators are contacted for a time sufficient to get to a desired molecular weight of the one or more polymers.

27. The method according to claim 22, wherein after a specified reaction time, or when the one or more polymers have reached a desired molecular weight, a quenching agent is added to terminate a polymerization reaction of the one or more of beta propiolactone and/or substituted beta propiolactones and comonomers with the one or more zwitterionic initiators.

28. The method according to claim 27, wherein the quenching agent is one or more of mineral acids, organic acids and acidic resins or solids.

29. The method according to claim 22, wherein after a specified reaction time, or when one or more polymers have reached a desired molecular weight an end capping agent is added, wherein the end capping agents comprises one or more electrophilic organic compounds.

30-32. (canceled)

33. A polymer according to claim 1, wherein the ratio of beta propiolactone and/or substituted beta propiolactone to the zwitterion is from about 500 to 1 to about 1,000,000 to 1.
